(19) United States
(12) Patent Application Publication
(10) Pub. No.: US 2025/0334533 A1
(43) Pub. Date: Oct. 30, 2025

(54) SYSTEM AND METHOD FOR MEASURING A LIQUID LEVEL AND ESTIMATING COOLING CAPACITY OF A COLD STORAGE CONTAINER

(71) Applicants: BOEHRINGER INGELHEIM VETMEDICA GMBH, Ingelheim an Rhein (DE); ALIZENT CANADA INC., Montreal (CA)

(72) Inventors: Pierre-Emmanuel DELIOU, Sugarhill, GA (US); Alain LECOURS, Montreal (CA)

(21) Appl. No.: 19/256,402

(22) Filed: Jul. 1, 2025

Related U.S. Application Data
(63) Continuation of application No. PCT/IB2024/050109, filed on Jan. 5, 2024.
(60) Provisional application No. 63/479,463, filed on Jan. 11, 2023.

(51) Int. Cl. G01N 25/00; G01F 23/24

(52) U.S. Cl. CPC G01N 25/00; G01F 23/246

(57) ABSTRACT

A method and system for measuring a liquid level within a cold storage container and/or determining its cooling capacity based on the liquid level includes a sensor column. The sensor column has a plurality of resistive temperature detectors (RTDs) positioned along its length. A central controller is coupled to the plurality of RTDs. A cold storage container receives the sensor column, wherein the central controller may determine a liquid level of a cryogenic liquid held within the cold storage container using the RTDs. And based on the liquid level determined, the central controller determines a remaining cooling capacity of the cold storage container as the cryogenic liquid evaporates/changes phase over time. The central controller may also detect other conditions of the container, such as, but not limited to, a tilt position, an opened state, and/or presence of the container on a moving vehicle.

### CROSS REFERENCE TO RELATED APPLICATIONS

This patent application claims the benefit of priority to U.S. Provisional Patent Application No. 63/479,463 filed on Jan. 11, 2023, which is incorporated herein by reference in its entirety.

### BACKGROUND

A cryogenic storage dewar, referred generally below as a cold storage container, is a specialized type of storage vessel/container used for storing cryogens (such as liquid nitrogen or liquid helium), whose boiling points are usually much lower than room temperature. Cold storage containers may take several different forms including open buckets, flasks with loose-fitting stoppers and self-pressurizing tanks. All cold storage containers usually have walls constructed from two or more layers, with a high vacuum maintained between the layers. This construction generally provides very good thermal insulation between the interior and exterior of the cold storage container, which reduces the rate at which the contents boil away.

One problem with cold storage containers is that it is very challenging to measure the liquid level inside of the cold storage containers, especially when the cooling liquid being used has boiling points much lower than room temperature, like liquid nitrogen. Liquid nitrogen is usually transported within cold storage containers at a temperature of about −196.0° C.

At these cold temperatures, the number and types of devices which can accurately measure liquid level inside the cold storage containers are very limited. Very simple hardware must be used and it cannot include electronic components or moving parts. When dealing with cryogenic materials, issues generally arise with water crystallization, thermal expansion, and material embrittlement.

Another problem with cold storage containers is that it is very challenging to monitor their temperature and liquid level during their transport: especially when they are being transported by one or more vehicles, such as, but not limited to, a truck, train, ship, or an airplane.

Companies which use cold storage containers to ship important and expensive products, like vaccines, embryos, semen, or other biological samples, often want to track and monitor the temperature being maintained by each cryogenic storage container during its transport. Products, like vaccines, may become ineffective if the product is exposed to temperatures above temperature ranges maintained by cryogenic liquids (i.e. temperatures within cryogenic cold storage containers may be several degrees above −196.0° C. and still preserve a product's life).

Another problem faced when using cold storage containers is that there have not been devices which can transmit temperature and liquid level data of the dewars back to a remote location during the time the cold storage container is being transported/shipped. During transport of liquid nitrogen, the liquid nitrogen slowly changes phase (i.e. changes into a gas) and evaporates and/or leaves the cold storage container. As the liquid nitrogen changes phase and leaves the cold storage container, the time the content of the container remains at a safe temperature decreases as the liquid level drops.

Accordingly, what is needed in the art is a method and system which can measure a level of liquid nitrogen within a cold storage container. Further, another need in the art is for a method and system which can determine if a cold storage container has been tipped over. Another need is for a method and system which can predict and/or project the amount of cooling capacity remaining in a cold storage container as the liquid nitrogen is evaporating during its transport.

There is a further need in the art for a method and system that measures and calculates the aforementioned readings and is able to transmit these readings wirelessly and over a computer communications network (i.e. The Internet) as the cold storage container is being shipped. There is also a need for a method and system to maintain cryogenic temperatures for cold storage containers once they reach their destination and for determining when a refill of a cryogenic liquid is needed before the cold storage capacity has been reached.

### SUMMARY OF THE DISCLOSURE

Briefly, the present disclosure is related to a system and method for measuring a liquid level and/or/determining a cooling capacity of a cold storage container.

The sensor device may be configured as a sensor column, which particularly has a length or length dimension. The detectors may be temperature detectors, for example resistive temperature detectors (RTDs). The resistive temperature detectors (RTDs) may be positioned along the length dimension and the sensor column may be placed within a central region of the cold storage container. The system may further comprise a controller, for example a central controller, coupled to the sensor device, the detectors or RTDs. Moreover, the system may have a cold storage container receiving or comprising the sensor device/column.

The (central) controller and/or the sensor device is/are configured to measure or determine a liquid level within the cold storage container using the sensor device. The (central) controller determines or is configured to determine a cooling capacity of the cold storage container based on the measured liquid level.

The system comprising the sensor device and the controller may also form a separate, independently realizable aspect of the present invention. Thus, it is not mandatory that the system comprises the cold storage container.

According to another aspect which may also be realized independently, the present invention relates to a method for determining a cooling capacity of a cold storage container. The method may be performed with a system as described herein and the system as described herein may be configured to perform a method as described herein.

The method may comprise providing a sensor device having a plurality of detectors for detecting a liquid level within the cold storage container, for example resistive temperature detectors (RTDs), and a controller coupled to the sensor device and/or the detectors. Thus, in one exemplary embodiment, the method comprises forming a sensor column by positioning a plurality of RTDs along a length or length dimension of the sensor column and coupling the RTDs to a central controller.

Further, the method may comprise placing the sensor device or sensor column in contact with a liquid being contained by the cold storage container. For example, the sensor device is placed within the cold storage container, for example in a central region thereof, and within the liquid.

Moreover, the method may comprise measuring the liquid level within the cold storage container with the sensor device, the detectors and/or the controller; and determining with the controller a cooling capacity of the cold storage container based on the measured liquid level.

With the present method and/or system, a robust, reliable, simple and/or efficient determination of a liquid level within and/or cooling capacity of a cold storage container can be made possible. This is conducive to a safe use of a cold storage container. Further, interruptions of a cold chain during transport with the cold storage container may be avoided.

The controller may determine or may be configured to determine if the cold storage container is in a tilt position, for example based on a signal from a tilt sensor and/or accelerometer coupled to the controller. A tilt position may be a position in which a longitudinal, central and/or symmetry axis of the cold storage container and/or the sensor device is aligned non-vertically. In a normal or non-tilt position, the longitudinal, central and/or symmetry axis of the cold storage container may be aligned vertically. Tilting of the cold storage container may cause cryogenic liquid to leak from the container.

As the cooling capacity preferably depends on or is determined by the amount of cryogenic liquid in the container, leaking cryogenic liquid usually results in a lowered cooling capacity. A determination/detection of a tilt position or tilting thus allows to detect a potential leak of cryogenic liquid, and a corresponding warning, alarm and/or message may be generated and/or a detected tilt position be incorporated in the determination of the cooling capacity, for example by setting the determined cooling capacity to a lower value when a tilting or tilt position has been detected or determined. The use of the container is thus made safer and/or more reliable and interruptions of a cold chain can be reduced, avoided or at least detected.

In an exemplary embodiment, the controller may determine or may be configured to determine if a container closure has been opened or removed from the cold storage container, for example based on a signal from a hall effect sensor coupled to the controller. An opening and/or removing of the container closure may lead to an increased temperature inside the container, at least for a short period of time, which may result in an interruption of the cold chain and/or an increased loss or evaporation of cryogenic liquid and, accordingly, a reduced cooling capacity. Thus, the determination of an opening or removal of the container closure is conducive to a more reliable and/or exact determination of the cooling capacity and/or a safe use of a cold storage container.

The controller may further determine or may be configured to determine if the cold storage container is being transported by an aircraft, for example based on a signal from an accelerometer and/or a barometer coupled to the controller. Further, the controller may determine or may be configured to determine if the aircraft is in a take-off or landing procedure. This allows functions of the system or cold storage container to be adapted, for example to activate or deactivate certain functions. Further, a detailed tracking of the transport or transport conditions of a product transported with the cold storage container is made possible and/or enhanced.

The controller may also wirelessly transmit or may be configured to wirelessly transmit data, for example the measured liquid level and/or the determined cooling capacity, over a computer communications network to a remote location or device. With this, a detailed and/or real-time tracking of the transport or transport conditions of a product transported with the cold storage container is made possible and/or enhanced.

The controller may temporarily disable wireless transmissions if it has been determined that the aircraft is in a take-off or landing procedure or may be configured thereto. This makes possible or facilitates a transport by an aircraft, where it is frequently required to shut off wireless data transmission during take-off or landing, while at the same time enabling a tracking of the transport or transport conditions of a product transported with the cold storage container that is as detailed and/or complete as possible.

The controller may determine or may be configured to determine the liquid level within the cold storage container by heating the detectors. The determination of the liquid level may be based on temperatures measured with the detectors before and after heating. Further, the controller may perform or may be configured for performing the heating in a predetermined sequence. By this, the liquid level and/or cooling capacity can be measured or determined in a simple and/or reliable way.

The heating of the detectors or the heating in the predetermined sequence may allow the controller to detect if one or more of the detectors is/are in presence of or in contact with a liquid or a gas. By this, the liquid level and/or cooling capacity can be measured or determined in a simple and/or reliable way.

The detectors may be temperature detectors, for example resistive temperature detectors (RTDs). These detectors have proven to be robust and reliable in the presence of cryogenic liquids and the challenging conditions accompanied therewith.

The detectors may be positioned along a length of the sensor device and/or along a straight line, for example in equal distances, and/or the sensor device may be configured as a sensor column. This configuration is particularly suitable for efficiently and reliably determining the liquid level within the cold storage container.

A liquid that is contained in the cold storage container for cooling purposes and/or provides the liquid level being measured within the cold storage container may be or comprise a cryogenic liquid, for example at least one of liquid nitrogen, liquid helium, liquid neon, liquid hydrogen, liquid argon, liquid krypton, liquefied methane, liquefied carbon monoxide, and liquefied natural gas.

The cooling capacity may be expressed in units of time, for example days. In other words, the cooling capacity may be the remaining amount of time for which the cold storage container will remain at or below a certain or desired temperature, for example a boiling point of a cryogenic liquid in the cold storage container. For example, when liquid nitrogen is used as cryogenic liquid in the cold storage container, the cooling capacity may be the remaining time for which the cold storage container will remain at or below the temperature of (at least approximately) −195.8° C. The cooling capacity may be expressed in days, but other time increments are possible.

The units of time in which the cooling capacity is expressed may be or comprise at least one of days, hours, minutes, seconds, and milliseconds.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1A illustrates a side view of a cork or plug of a liquid level and cooling capacity measuring system;

FIG. 1B illustrates a side perspective view of the cork illustrated in FIG. 1A;

FIG. 1C illustrates another side perspective view of the cork illustrated in FIGS. 1A-1B;

FIG. 2A illustrates a side perspective and top view of the cork of FIG. 1A, but with a cover/lid removed which allows several modules for the liquid level and cooling capacity measuring system to be seen;

FIG. 2B illustrates a side perspective and bottom view of the cork of FIG. 1A, but with a cover/lid removed;

FIG. 2C illustrates a side perspective and bottom view of the cork of FIG. 1A and with a section removed that reveals a communication line that couples the modules of FIG. 2A with temperature/level probe (RTDs) present within a column;

FIG. 3 illustrates a top view of the modules and circuit board illustrated in FIG. 2A;

FIG. 4 is a schematic of how the liquid level and cooling capacity measuring system is coupled to a cryogenic storage dewar;

FIG. 5 is a schematic of a few of the modules of FIG. 2A that are coupled to the RTDs found within the columns shown in FIGS. 1A-2C;

FIG. 6 is a side view of a column which contains a plurality of RTDs that are coupled to the modules of FIG. 5 and FIG. 2A;

FIG. 7 is a side view of a printed circuit board (PCB) that fits within the column of FIG. 6 and which holds the RTDs at predetermined locations along the length of the PCB;

FIG. 8 is a magnified view of two RTDs illustrated in FIG. 7;

FIG. 9 is a graph that has temperature on its Y-axis and time of temperature measurement on the X-axis; and

FIG. 10 is a logic flow chart illustrating exemplary steps of a method for measuring a liquid level and a cooling capacity of a cold storage container;

FIG. 11A illustrates an exemplary graphical user interface (GUI) that can be displayed on the display device illustrated in FIG. 4;

FIG. 11B illustrates an exemplary embodiment of a GUI that is generated in response to a “menu” command being selected in FIG. 11A;

FIG. 11C illustrates an exemplary GUI that is generated in response to the “Status” option being selected in the GUI of FIG. 11B;

FIG. 11D illustrates an exemplary GUI that is generated in response to the “Process” option being selected in the GUI of FIG. 11C;

FIG. 11E illustrates an exemplary GUI that is generated in response to the “Device” option being selected in the GUI of FIG. 11C;

FIG. 11F illustrates an exemplary GUI that is generated in response to the “Next” option being selected in the GUI of FIG. 11E;

FIG. 11G illustrates an exemplary GUI that is generated in response to the “Next” option being selected in the GUI of FIG. 11F;

FIG. 11H illustrates an exemplary GUI that is generated in response to the “Communication” option being selected in the GUI of FIG. 11C;

FIG. 11-I illustrates an exemplary GUI that is generated in response to the “Alarm” option being selected in the GUI of FIG. 11B;

FIG. 11J illustrates an exemplary GUI that is generated in response to the “Current” alarm option being selected in the GUI of FIG. 11-I;

FIG. 11K illustrates an exemplary GUI that is generated in response to the “Current” alarm option being selected in the GUI of FIG. 11-I and/or in response to the “Next” option being selected in the GUI 1100J in FIG. 11J;

FIG. 11L illustrates an exemplary GUI that is generated in response to the “Current” alarm option being selected in the GUI of FIG. 11-I and/or in response to the “Next” option being selected in the GUI in FIG. 11K;

FIG. 11M illustrates an exemplary GUI that is generated in response to the “Current” alarm option being selected in the GUI of FIG. 11-I and/or in response to the “Next” option being selected in the GUI in FIG. 11L;

FIG. 11N illustrates an exemplary GUI that is generated in response to the “Alarm History” option being selected in the GUI 1100-I of FIG. 11-I;

FIG. 11-O illustrates an exemplary GUI 1100-O that is generated in response to the “Communication” option being selected in the GUI 1100C of FIG. 11C;

FIG. 11P illustrates an exemplary GUI that is generated in response to the “Enable” option being selected in the GUI of FIG. 11-O;

FIG. 11Q illustrates an exemplary GUI that is generated in response to the “Mode” option being selected in the GUI of FIG. 11-O;

FIG. 11R illustrates an exemplary GUI that is generated in response to the “Config wifi” option being selected in the GUI of FIG. 11-O;

FIG. 11S illustrates an exemplary GUI that is generated to activate Bluetooth™ wireless communications (i.e. “Activate BLE”);

FIG. 11T illustrates an exemplary GUI exemplary GUI that is generated to calibrate various sensors, such as, but not limited to, the RTDs, temperature sensors, and accelerometers;

FIG. 11U illustrates an exemplary GUI that is generated in response to the “Calibrate RTD” option being selected in the GUI of FIG. 11T;

FIG. 11V illustrates an exemplary GUI that is generated in response to the “Calibrate Out Temp” option being selected in the GUI of FIG. 11T;

FIG. 11W illustrates an exemplary GUI that is generated in response to the “Calibrate ACCEL” option being selected in the GUI of FIG. 11T;

FIG. 11X illustrates an exemplary GUI that is generated to adjust the reading intervals of the sensor column and the transmit interval/timing for the measuring system to communicate with the remote computing device of FIG. 4;

FIG. 11Y illustrates an exemplary GUI that is generated in response to the “Reading Interval” option being selected in the GUI of FIG. 11X;

FIG. 11Z illustrates an exemplary GUI that is generated in response to the “Transmit Interval” option being selected in the GUI of FIG. 11X;

FIG. 12A illustrates an exemplary GUI that is generated to select a development mode for the measuring system;

FIG. 12B illustrates an exemplary GUI that is generated to allow an operator to shut down or turn off the measuring system of the container;

FIG. 12C illustrates an exemplary GUI that is generated to allow an operator to select the type of power source (i.e. battery type) for the measuring system;

FIG. 12D illustrates an exemplary GUI that is generated to allow an operator to select and view a data history for certain data parameters tracked by the measuring system;

FIG. 12E illustrates an exemplary GUI that is generated in response to the “Voltage” history option being selected in the GUI of FIG. 12D;

FIG. 12F illustrates an exemplary GUI that is generated in response to the “Voltage” graph option being selected in the GUI of FIG. 12E; and

FIG. 12G illustrates an exemplary GUI that is generated to allow an operator to couple a remote computing device to the measuring system by producing a two-dimensional bar-code on the display device.

### DETAILED DESCRIPTION

The term “exemplary” is used herein to mean “serving as an example, instance, or illustration.” Any aspect described herein as “exemplary” is not necessarily to be construed as preferred or advantageous over other aspects.

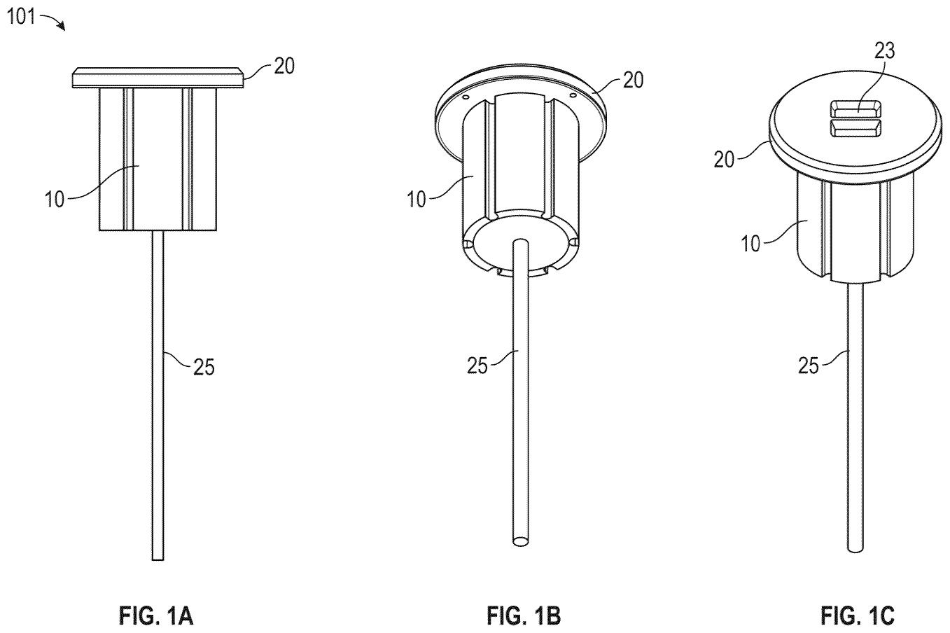

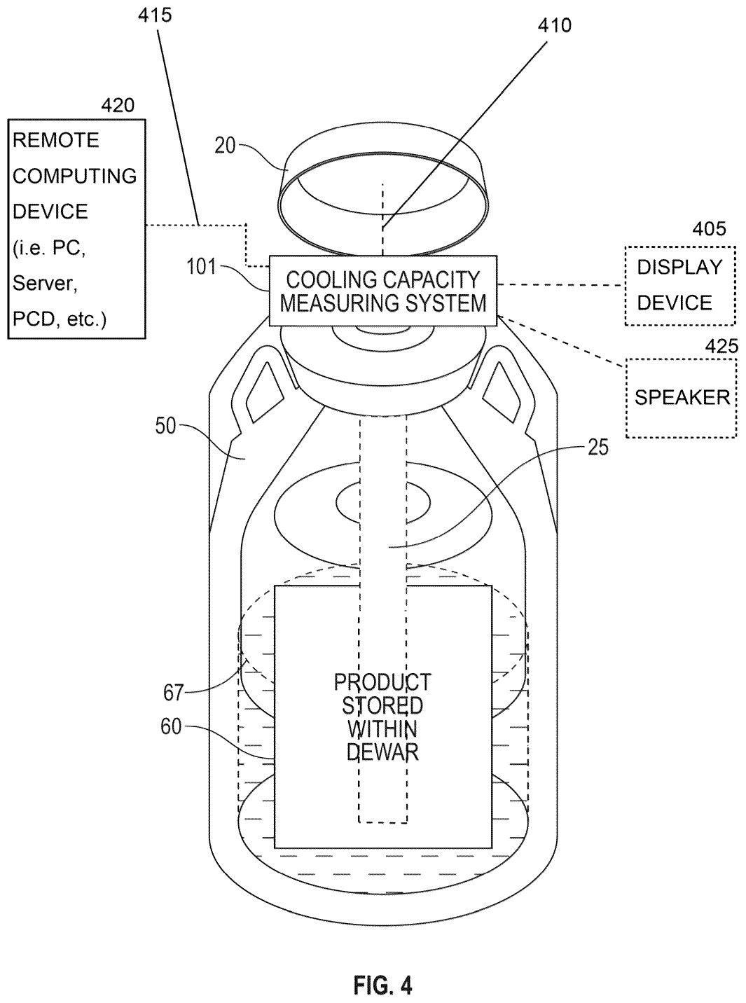

Referring now to the drawings, wherein the showings are for purposes of illustrating certain exemplary embodiments of the present disclosure only, and not for purposes of limiting the same, FIG. 1A illustrates a side view of a container closure 10 (also denoted as cork 10 or plug 10 as follows) of a liquid level and cooling capacity measuring system 101. The container closure, cork, or cork 10 further has a cover or top 20. Coupled to the cork/plug (or “container closure”) 10 is a sensor device 25 that will be positioned within a cold storage container 50 (see FIG. 4), for example in a central region of the cold storage container 50. The sensor device 25 may be elongated and/or embodied as a sensor column. Generally, other locations than a positioning the sensor device 25 within a central region of the cold storage container 50 are possible. For example, the sensor device 25 could also be arranged at and/or integrated into a sidewall of the cold storage container 50.

Referring now to FIG. 1B, this figure illustrates a side perspective view of the cork 10 illustrated in FIG. 1A. The cork 10 may have a cylindrical shape and it may be constructed from styrofoam type insulating materials. However, other shapes/geometries for the cork 10 are possible and are included within the scope of this disclosure. Similarly, other materials for the cork 10 are possible and are also included within the scope of this disclosure.

Referring now to FIG. 1C, this figure illustrates another side perspective view of the cork 10 illustrated in FIGS. 1A-1B. The cover or top 20 may further include grooves 23 that may function as a handle for lifting the cork 10 out of a container 50 (See FIG. 4 for the container 50). Other types of handles besides grooves/indentations 23 are possible and are included within the scope of this disclosure.

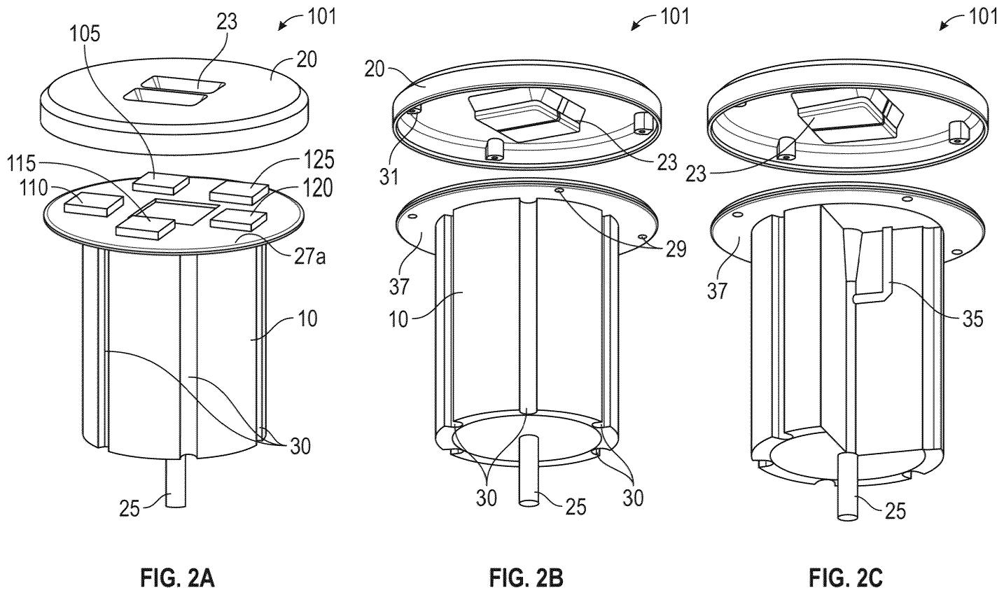

Referring now to FIG. 2A, this figure illustrates a side perspective and top view of the cork 10 of FIG. 1A, but with a cover/lid 20 removed which allows several modules 105, 110, 115, 120, 125 for the liquid level and cooling capacity measuring system 101 to be visible. The modules may include, but are not limited to, a processor module 105, a sensor module 110, an acquisition module 115, a power module 120, and a communications/wireless module 125. Each of the modules may be implemented in hardware, software, firmware, or any combination thereof as understood by one of ordinary skill in the art. The modules may be positioned within a circular printed circuit board (PCB) 27a.

The wireless module 125 of FIG. 2A is responsible for communication with other computer communication networks, such as, but not limited to, the Internet. It may send telemetry data and can also receive data like setpoints or firmware updates for the system 101. The processor module 105 may be the main controller or central controller for the system 101. In the following, the processor module 105 is thus also denoted as “central controller” or simply “controller.”

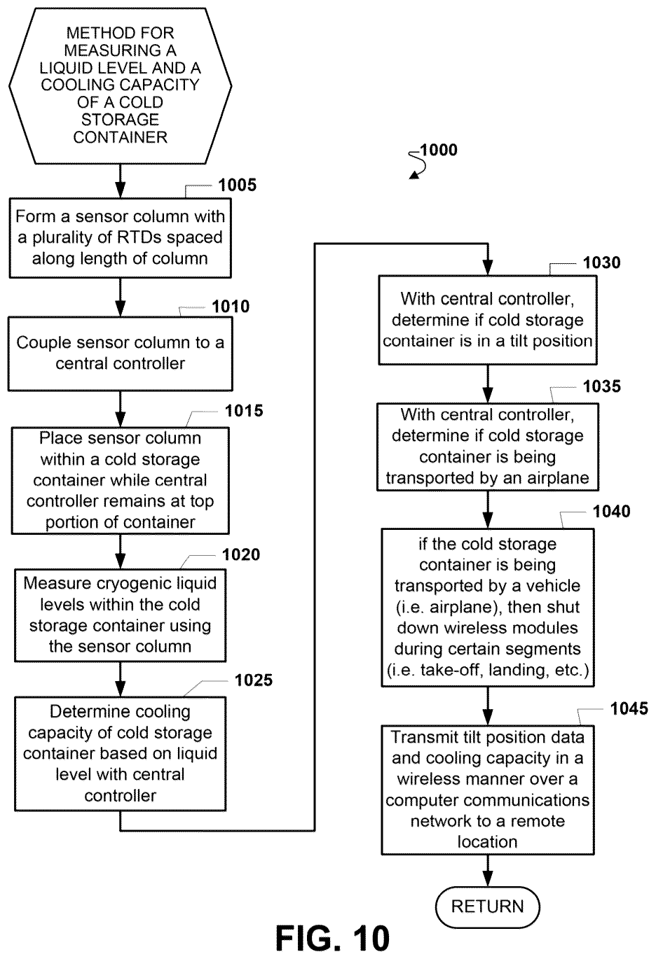

In particular, the terms “processor module” and “central controller” 105 may be replaced by the term “controller” 105. The processor module or controller 105 processes the liquid level measurements and evaluates any fault/warning situations. The processor module or controller 105 may comprise a general-purpose processor/computer that is specifically programmed/specially programmed according to the flow chart steps illustrated in FIG. 10 described below. The processor module or controller 105 may have built-in memory, such as cache-type and/or DRAM type memory as understood by one of ordinary skill in the art, where such memory may store the programming steps detailed in FIG. 10 described below.

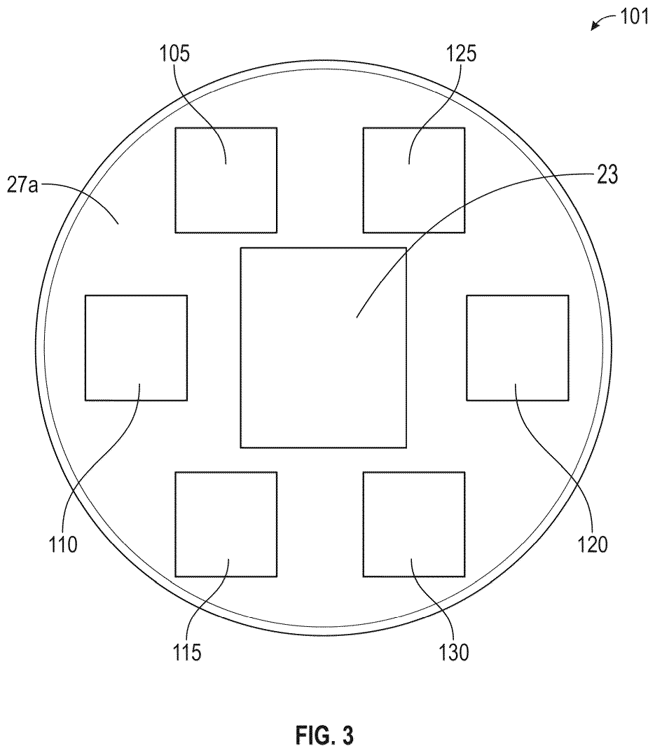

The sensor module 110 may comprise a processor that is coupled to one or more sensors located on the system main board 27a. The sensors may include, but are not limited to, board temperature, ambient temperature, barometric pressure, accelerometer and hall effect switches. Further details about the sensor module 110 will be described below in connection with FIG. 3.

The power module 120 is generally responsible for providing power to all modules illustrated in FIG. 2A. It converts the power from the power source 130 (see FIG. 3—i.e. usually, but not limited to, a battery, one or more capacitors, or a combination thereof) and regulates the voltage for a stable device operation. The power source 130 (see FIG. 3) provides the power module 120 with the necessary energy to run the device/system 101. Power sources will generally be long lasting primary batteries such as Lithium-iron or lithium-manganese batteries as example. Lithium-ion rechargeable batteries are generally not used if the system 101 is being transported by an airplane, due to the flammable nature of such batteries as understood by one of ordinary skill in the art.

Each cork or plug 10 may further include grooves or indentations 30 in the side geometry of the cork 10. These grooves 30 may couple with protrusions/projections (not visible/shown) that may be part of the container 50 (See FIG. 4) such that the cork 10 is placed in a proper orientation when put into a top portion of the container 50.

Referring now to FIG. 2B, this figure illustrates a side perspective and bottom view of the cork 10 of FIG. 1A, but with a cover/lid 20 removed. The cover 20 may be fastened to the bottom part of the enclosure 37 by fasteners (not shown), such as, but not limited to, screws. The fasteners may penetrate holes 29 within the bottom part of the enclosure 37. The holes 29 may also penetrate/pass through the printed circuit board 27a. The fasteners may also contact or couple to posts 31 which are part of the cover/lid 20. Other fasteners are possible. Other fasteners include adhesives, rivets, locking structures, and the like.

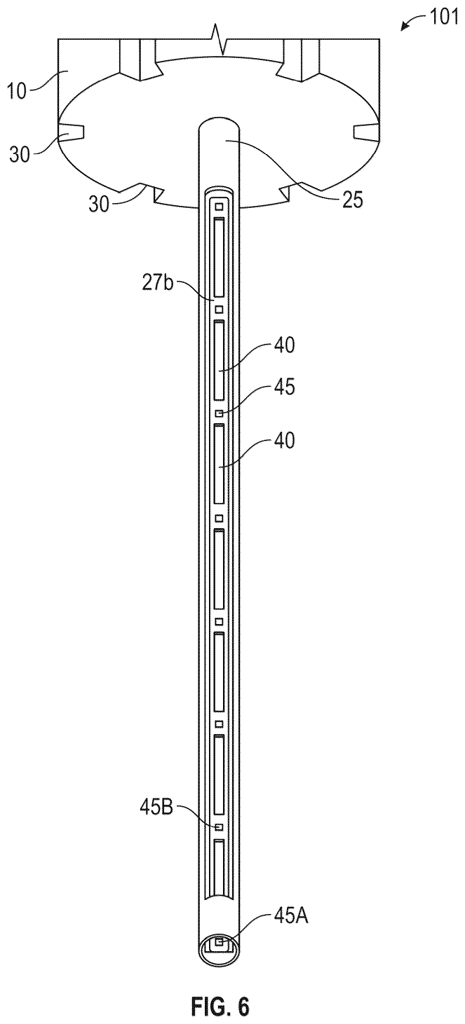

Referring now to FIG. 2C, this figure illustrates a side perspective and bottom view of the cork 10 of FIG. 1A and with a section removed. The removed section of the cork 10 reveals a communication line 35 that couples the modules of FIG. 2A with resistive temperature detectors (RTDs) 45 (not shown in FIG. 2C, but see FIGS. 6-8) present within the column 25. Further details about the RTDs 45 and column 25 will be described below.

FIG. 3 illustrates a top view of the modules and circuit board 27a illustrated in FIG. 2A. As noted previously, the sensor module 110 may include a plurality of sensors that include, but are not limited to, barometric pressure sensors, tilt sensors, accelerometers, hall effects switches, and magnets. The tilt sensor(s) may be configured as an accelerometer, liquid capacitive inclinometer, electrolytic tilt sensor, MEMS tilt sensor, gyroscope, or any combination thereof.

The barometric pressure sensors, tilts sensors, and/or accelerometers (“sensors” 110) are preferably used to detect whether the system 101 is being transported by a vehicle, such as an airplane. The tilt sensor and/or accelerometer may also be used to detect a tilt situation. The hall effect switched (magnetic switches) are used in conjunction with magnets installed on the container 50 to detect the removal of the cork 10/lid 20 from the cold storage container 50 (See FIG. 4).

According to one exemplary embodiment of the system 101, the hall sensors of the sensor module subsystem 110 may be used to detect magnets positioned in the neck of the cold storage container 50. So when the cork 10 and/or system 101 is removed from the neck of the cold storage container 50 there is a detection and log of the time of the opening/closing by the central controller 105. Thus, the central controller 105 may determine if the cork 10 and/or system 101 been opened or removed from the cold storage container 50, or subsequently, the central controller 105 may determine if the system 101 is correctly positioned in the neck of the cold storage container 50.

According to another exemplary embodiment, the processor 105 may also put the wireless module 125 and other modules into an air-plane mode. In other words, when the sensor module 110 helps the processor 105 determine that the cold storage container 50 is being transported by an air-plane based on sensed acceleration and/or barometric pressure change of the container 50, then the processor 105 can shut-off the wireless module 125 and/or other modules or put these modules in an air-plane mode where no data is wirelessly transmitted to be in compliance with air freight standards known as of this writing (i.e. DO-160, Environmental Conditions and Test Procedures for Airborne Equipment published by the Radio Technical Commission for Aeronautics).

Referring now to FIG. 4, this figure is a schematic/functional block diagram of how the liquid level and cooling capacity measuring system 101 is coupled to a cryogenic storage dewar or cold storage container 50. The system 101 is generally positioned on a PCB 27b (see FIGS. 2A & 3) which is coupled to the lid 20 and the main body of the cork 10 (see FIGS. 1A-2C) via a mechanical connection(s) 410. The mechanical connections 410 may comprise the fasteners (not illustrated) and/or holes/apertures 29 described above in connection with FIGS. 2B-2C.

The cork 10 is used to close the cryogenic storage container 50. The column 25 coupled to the cork 10 and the system 101 may penetrate the middle of the container 50 so that it may contact the liquid cooling medium 67, which may comprise a cooling/cryogenic liquid/cooling medium, such as, but not limited to, liquid nitrogen (N2). The product 60 may surround/envelope the column 25 and the product is usually positioned within the cooling medium 67. The shape of the container 50 is merely exemplary. Also, other cryogenic liquids/cooling mediums 67, beside liquid nitrogen (N2), may be used without departing from the intent and scope of this disclosure. Other cryogenic liquids 67 include, but are not limited to, liquid helium, liquid neon, liquid hydrogen, liquid argon, liquid krypton, liquified methane, liquefied carbon monoxide, and liquefied natural gas.

Additionally, other shapes of the container 50 besides the one illustrated in FIG. 4 are possible and are included within the scope of this disclosure. The container 50 may be manufactured, as of this writing, by CHART Industries Inc. of Ball Ground, Georgia [https://www.chartindustries.com]. Other suppliers for the container are possible and may be used with the inventive measuring system 101.

From FIGS. 1 to 4 and FIGS. 6 to 8, an exemplary embodiment of the system 101 (shown for example in FIGS. 2A, 3 and 4) according to the invention is apparent, wherein the system 101 is configured for measuring a liquid level within a cold storage container 50 (shown in FIG. 4) and determining its cooling capacity based on the liquid level, the system 101 comprising: a sensor column 25 (shown in FIGS. 1, 2 and 4), having a length dimension and a plurality of resistive temperature detectors (RTDs) 45 (shown in FIGS. 6 to 8) positioned along the length dimension, the sensor column 25 being placed within a central region of the cold storage container 50; a central controller 105 coupled to the plurality of RTDs 45; and the cold storage container 50 receiving the sensor column 25, wherein the central controller 105 may determine a liquid level within the cold storage container 50, and based on the liquid level, the central controller 105 determines a cooling capacity of the cold storage container 50.

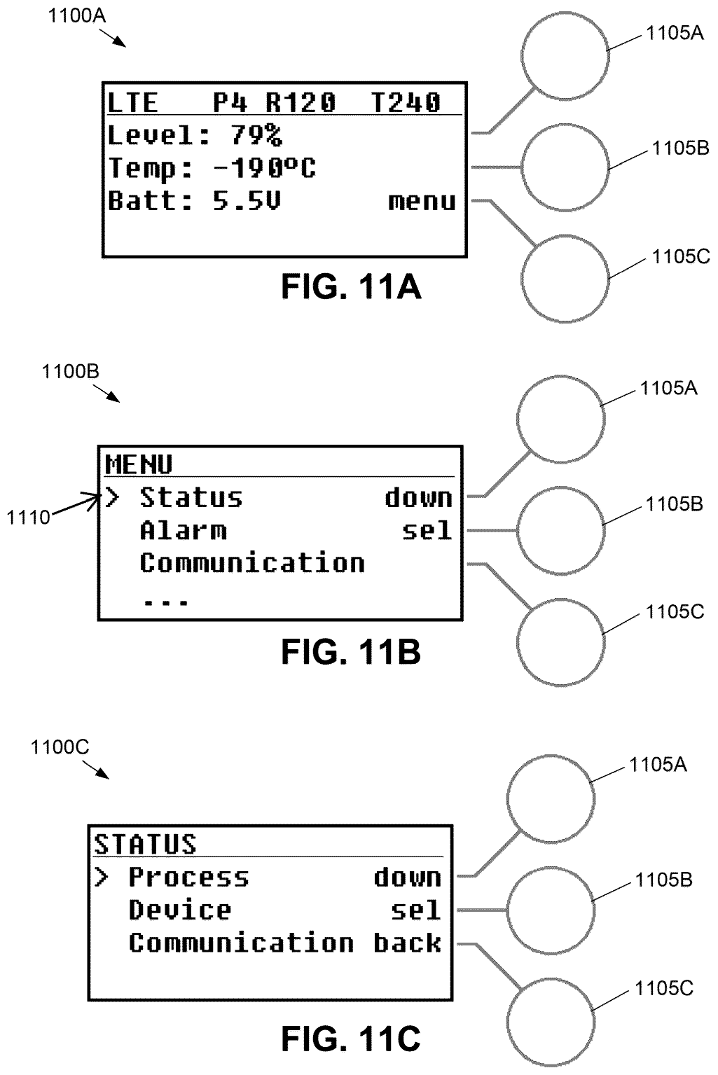

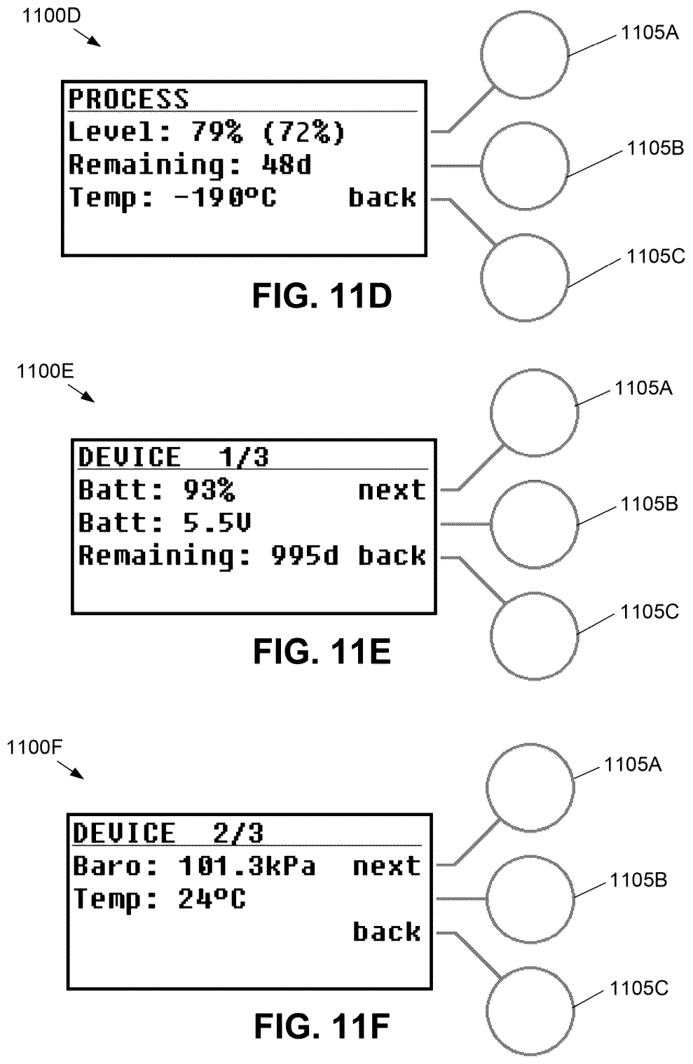

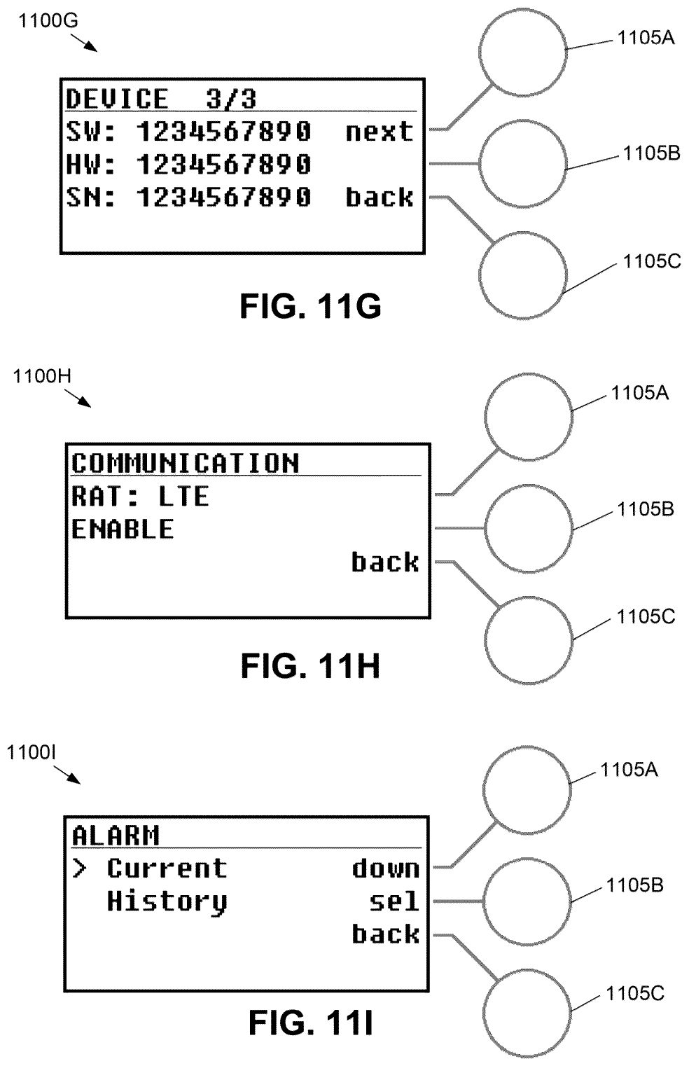

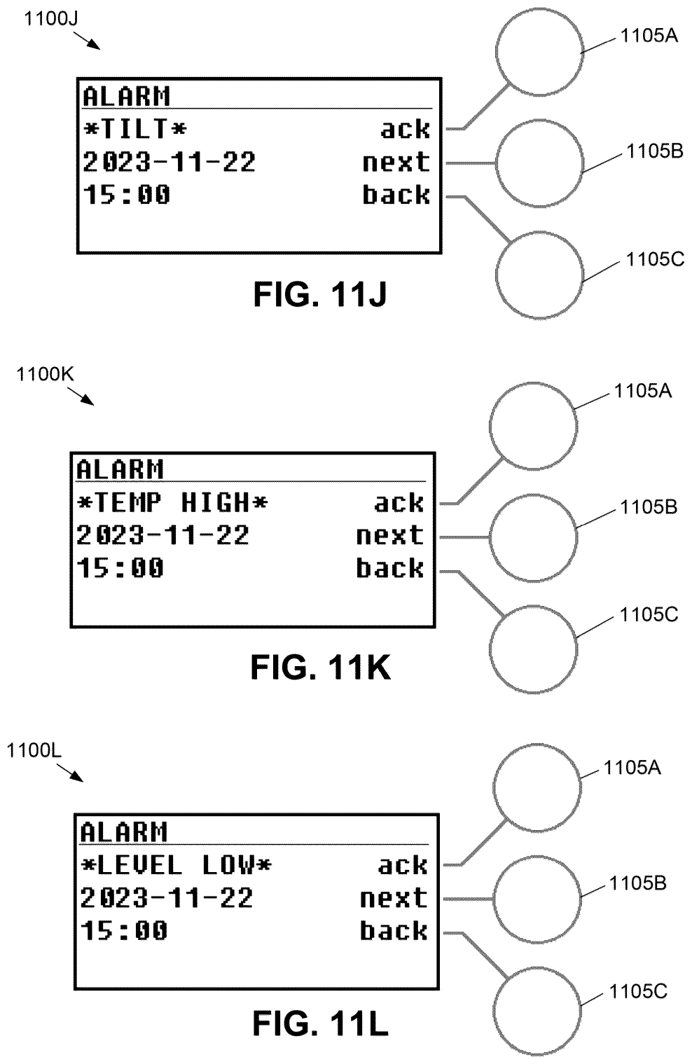

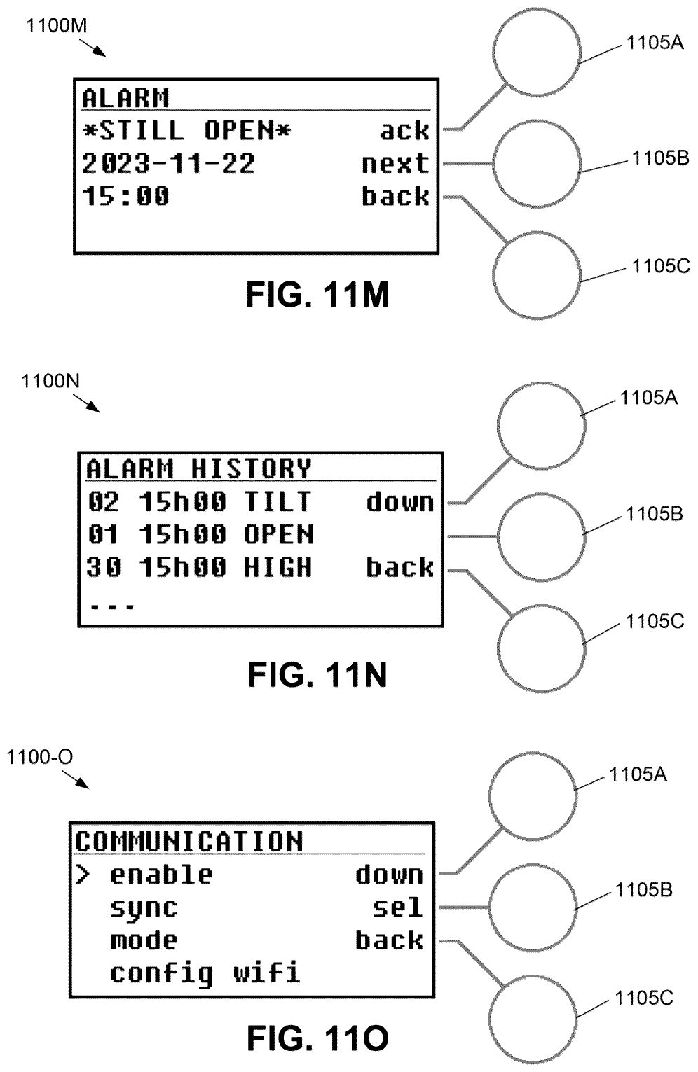

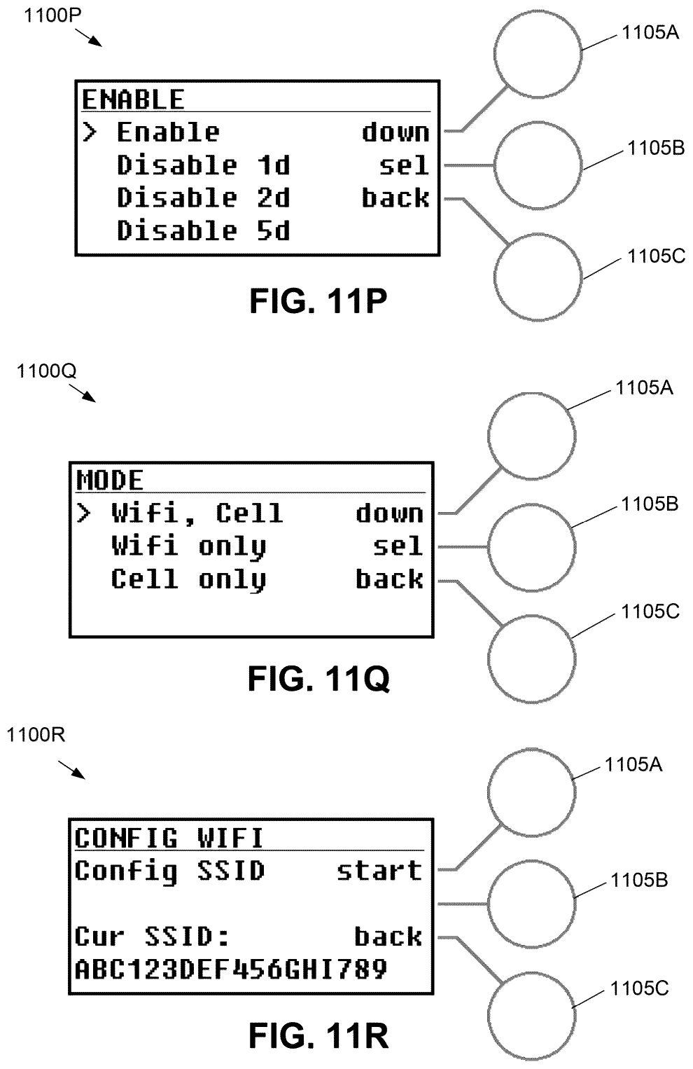

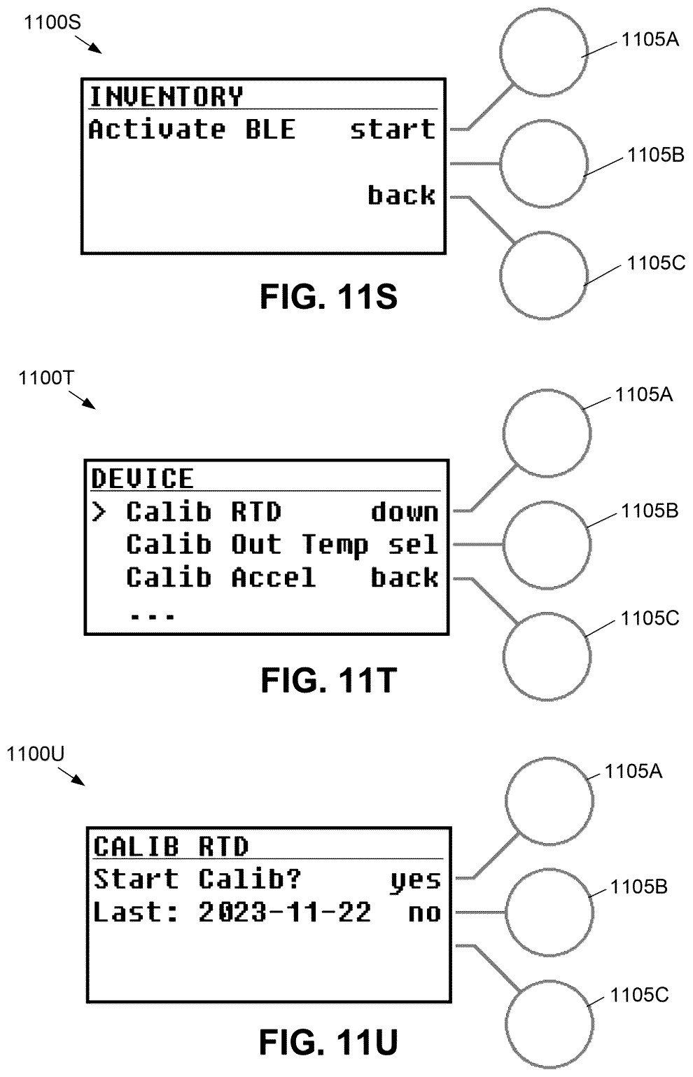

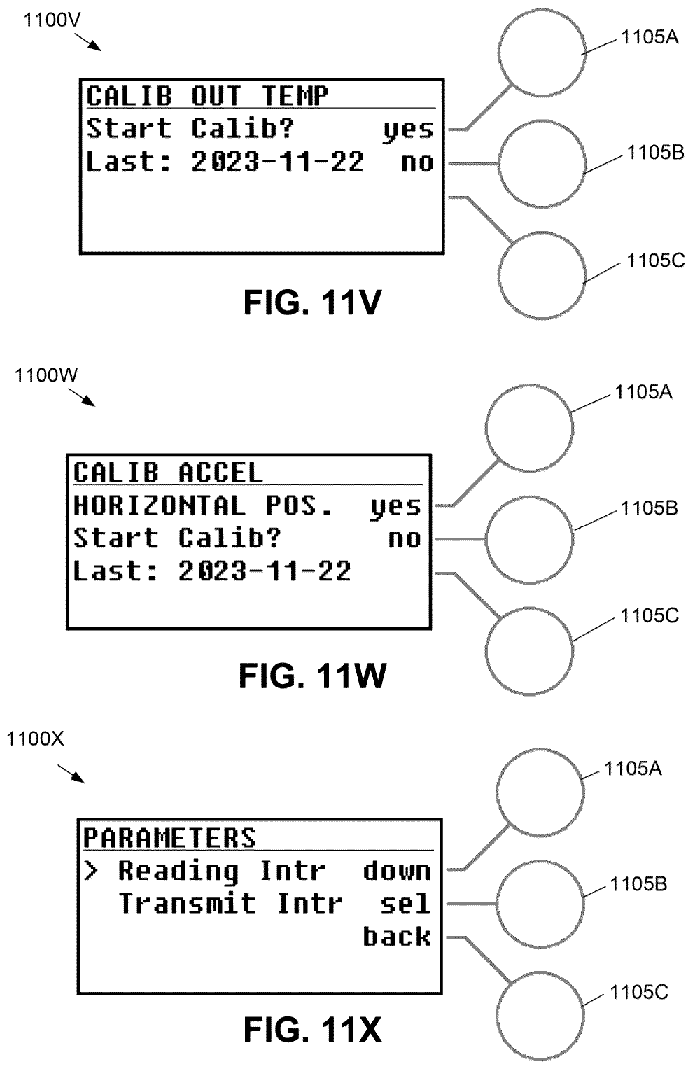

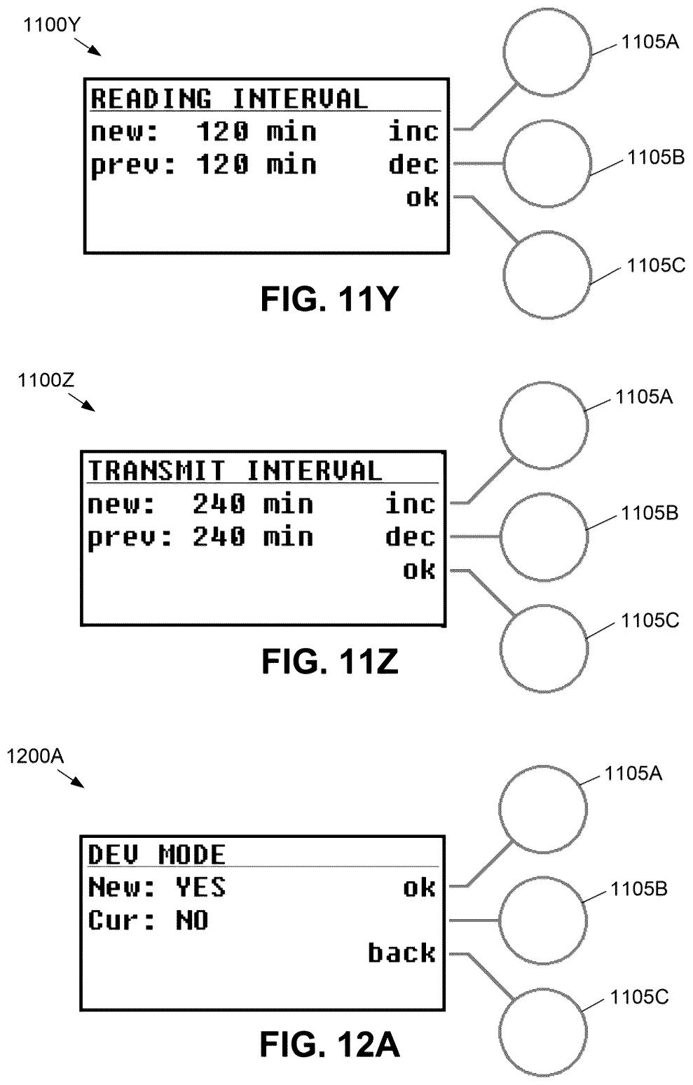

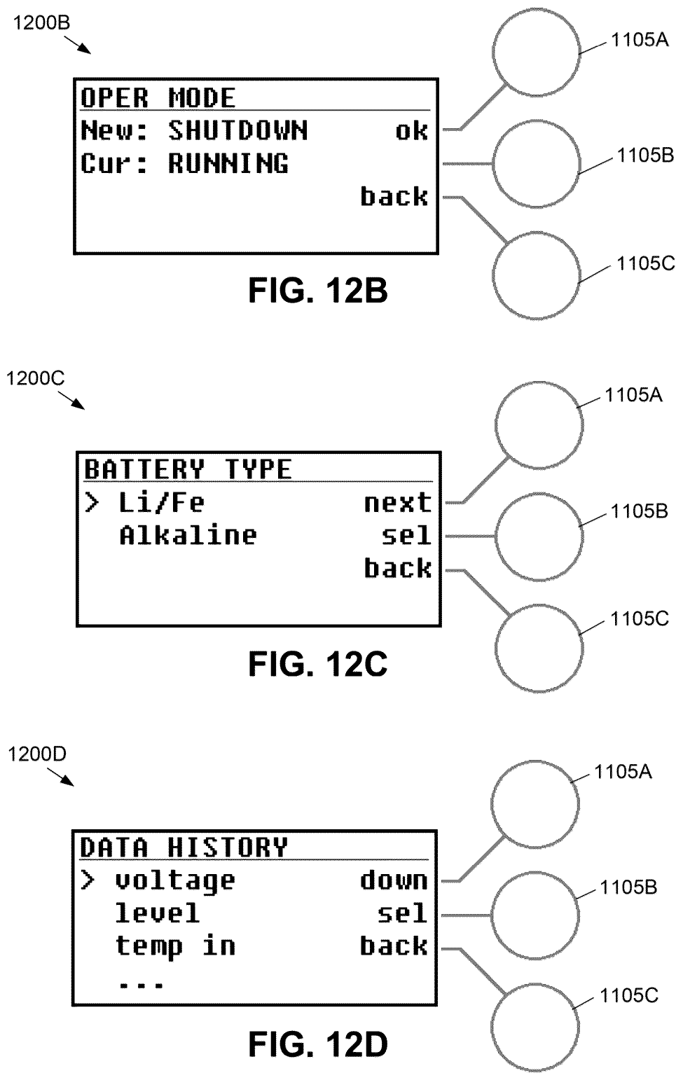

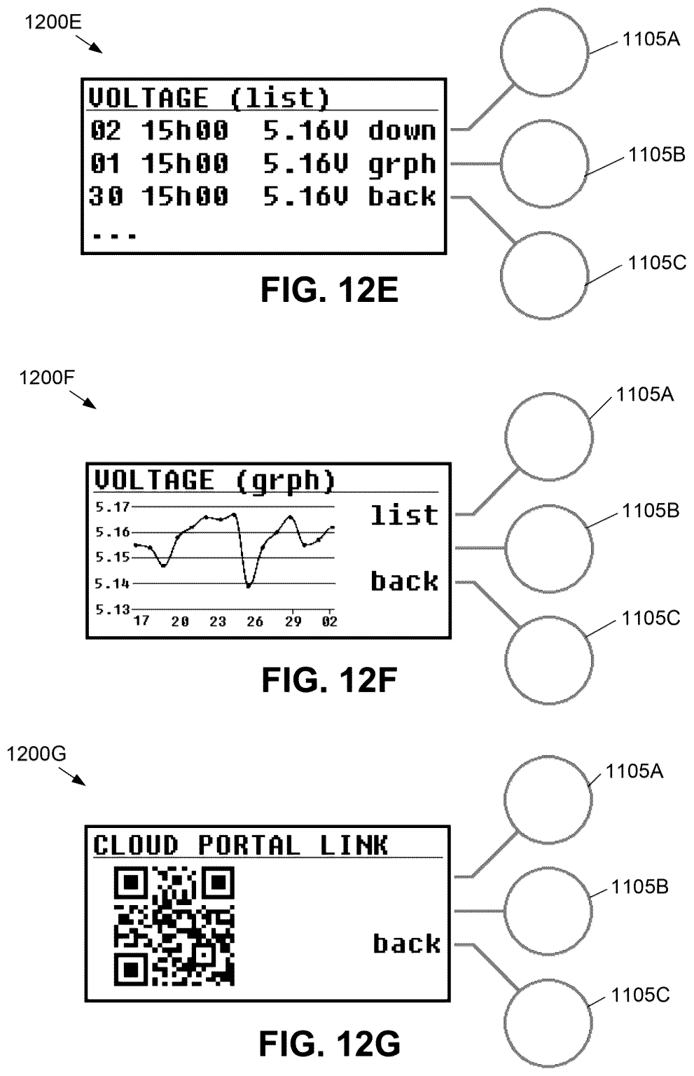

The measuring system 101 may also include a display device 405. The display device 405 can comprise any type of display device such as a liquid crystal display (LCD), a plasma display, an organic light-emitting diode (OLED) display, e-paper, e-ink, and other like display devices. The display device 405 may also comprise a touchscreen display as understood by one of ordinary skill in the art. The display device 405 may be used by the measuring system 101 to generate several graphical user interfaces (GUIs) described below in connection with FIGS. 11-12.

As described more fully herein and below, the measuring system 101 may convey several messages to an operator using the container 50 as well as transmitting these messages to one or more remote computing device(s) 420 using a communication link 415. The communication link 415 may comprise wired and/or wireless communication links. Wireless communication links 415 may comprise radio-frequency (RF) communications, acoustic communications, optical communications (like infrared communications), magnetic communications, and the like. The communication link 415 may also comprise a local area network (LAN) and/or a wide area network (WAN). Such networking environments are commonplace RF communications that cover enterprise-wide computer networks, intranets, and the Internet as understood by one of ordinary skill in the art.

The one or more remote computing devices 420 may comprise one or more personal computers (PCs), computer servers, and/or portable computing devices (PCDs). Each PCD may comprise at least one of a smartphone, a tablet personal computer (PC), a laptop, a smart watch, a wearable device, or any type of peripheral with a display. A smartphone PCD 420 may run one or more application (“App”) programs.

An App installed on a PCD 420 may be launched (“opened”) for reading messages from the measuring system 101 and/or for remotely controlling/programming the measuring system 101. For example, the “app” on the PCD 420 may allow an operator to see the several “Alerts” described and illustrated in connection with FIGS. 11-12. The “app” on the PCD 420 may allow an operator to adjust/or modify operating parameters of the measuring system 101 (i.e. adjust reading intervals of the sensor column 25, message transmitting intervals of the system 101, setting auto-off functions of the system 101 for airplane transport, etc.).

With larger display devices 405, remote computing devices 420 may display more information on respective screens compared to the graphical user interfaces (GUIs) illustrated in FIGS. 11-12. That is, it is recognized that with more screen real estate, several alarms and/or messages may be displayed at one time on remote computing devices 420 compared to the GUIs illustrated in FIGS. 11-12 described below. Further, the size of the display device 405 for system 101 may also be increased without departing from this disclosure. Therefore, two or more GUIs of FIGS. 11-12 could be displayed at the same time depending upon the respective size of the display device 405 utilized/coupled to the measuring system 101.

The measuring system 101 may also have another output device besides the display device 405, such as a speaker 425. The speaker 425 may generate an audible alarm that can be heard by humans. The speaker 425 may also be able to provide text-to-speech messages generated by the CPU/microcontroller 105 as understood by one of ordinary skill in the art. The text-to-speech message(s) may describe in a human-like voice what information is being displayed/conveyed by the measuring system 101 on the display device 405. The text-to-speech message(s) may also provide information beyond and/or different than what is currently displayed on the display device 405. The speaker 425 may also generate sounds like a buzzer to indicate any one of the alarm conditions described in more detail below in connection with FIGS. 11-12. The measuring system 101 may assign different sounds for different types of alarms that are triggered. That is, the measuring system 101 could assign a first sound for a first alarm and it could assign a second sound, different from the first sound, for a second alarm, etc.

Both the speaker 425 and display device 405 have been illustrated with dashed or dotted lines. These dashed or dotted lines mean that the speaker 425 and display device 405 are optional and are not required for exemplary embodiments of the measuring system 101.

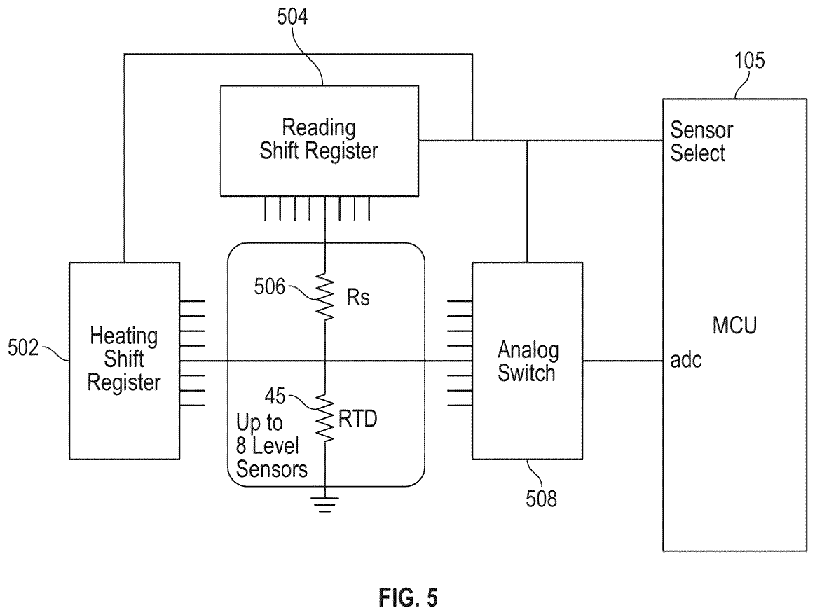

Referring now to FIG. 5 is a schematic of a few of the modules of FIG. 2A that are coupled to the RTDs 45 found within the column 25 shown in FIGS. 1A-2C. The processor module 105 may comprise a CPU or a microcontroller (MCU) as understood by one of ordinary skill in the art. The MCU or processor module 105 may be coupled to a reading shift register 504, a heating shift register 502, and an analog switch 508. These registers 502, 504, and analog switch 508 may be part of the acquisition module 115.

A resistor 506 is present within each RTD 45. Each resistor 506 is part of a voltage divider within each RTD 45. The resistor 506 is used to measure the RTD value by applying a known voltage to the divider circuit and reading the voltage result from the divider, as understood by one of ordinary skill in the art.

Meanwhile, the analog switch 508 allows the MCU 105 to read many analog values using only one analog-to-digital-converter (ADC) that is part of the switch 508. The MCU 105 will usually read the voltage of each divider circuit one by one by controlling the analog switch 508 and doing so, determine the RTDs resistance value as it relates to temperature.

The reading shift register 504 powers the divider circuits. Since the content of the shift register 504 can be anything, any divider circuit or combination of divider circuits can be powered on demand. Normally, the MCU 105 will quickly power the divider circuits one by one (and read the result with the analog switch 508 and its built-in ADC) to avoid self-heating that could change the reading value of a divider circuit powered for a long period of time.

The heating shift register 502 allows the heating of the RTD portion of the divider circuit. It is connected directly to the RTDs 45 to apply the maximum voltage and heat them as quickly as possible. Since the content of the heating shift register 502 can be anything, any RTD 45 or combination of RTDs 45 can be heated at the same time.

Each resistance temperature detector (RTD) 45 is a thermal/heat sensor used to measure temperature. An RTD 45 is generally made from either platinum, copper, or nickel. RTDs 45 usually have a repeatable resistance vs. temperature relationship and an operating temperature range of about −200° C. to about +850° C. However, other ranges below and above these two limits are possible and are within the scope of this disclosure.

Generally, for measuring temperature with RTDs 45, an electrical current is passed through the detector 45 and then voltage is measured: the voltage will usually indicate what is the resistance of the detector 45. A comparison table can be produced that provides a listing of temperatures corresponding to measured resistance of the detector 45. According to other exemplary embodiments, each RTD 45 may also use an algebraic arithmetic equation which calculates the temperature with the resistance value as an input, as understood by one of ordinary skill in the art.

During operation of an RTD 45, when an electrical current is propagated through the detector 45, the detector 45 will heat up due to its inherent resistance. According to one exemplary embodiment of the system 101 and method, the RTD 45 is read fast/quickly to get a first temperature. Then, an additional electrical current is applied (by applying its maximum voltage) to the RTD 45 over a predetermined period/interval of time. A second reading is performed to determine a second temperature for the RTD 45 after the RTD 45 has been heated by its inherent resistance.

If the second temperature is substantially greater than the first temperature after the RTD 45 has been heated with the additional electrical current propagated after the first temperature reading, then a gaseous phase has been detected at that RTD 45. This means the liquid nitrogen level 67 (See FIG. 4) is physically below this detector 45.

As noted below, according to one exemplary embodiment of the system 101 and method 1000, a plurality of detectors/RTDs 45, for example eight (8) RTDs 45, may be positioned at predetermined locations along a length of the column 25. These eight RTDs 45 will help locate the present location of the liquid nitrogen 67 level within a tank 50 (see FIG. 4). The detectors/RTDs 45 may be positioned in equal distances and/or along a straight line.

If the second temperature reading is about or approximately (i.e. “substantially”) equal to the first temperature, then a liquid (i.e. liquid nitrogen 67) has been detected by the detector 45. A liquid is detected by a particular RTD 45 when the second temperature is about or approximately (i.e. “substantially”) equal to the first temperature because the thermal inertia of the liquid (i.e. liquid nitrogen 67) is substantially higher than the thermal inertia of a gas (i.e. nitrogen gas).

Although it is not necessary to get an accurate temperature reading to get the level measurement working correctly, RTDs may be calibrated to get more precise temperature reading inside the container. According to one exemplary embodiment, the calibration of each RTD 45 is triggered by the user. The calibration will be done for all RTDs 45 if the highest RTD at the top of the cold storage container 50 is detected in the liquid 67.

Since the boiling temperature is changing with the barometric pressure, the calibration of all RTDs 45 is done at the same time even if the difference is not important (less than 1 deg Celsius in the usual barometric pressure range). This calibration of each RTD 45 can be done simultaneously since, as understood by one of ordinary skill in the art, liquid nitrogen 67 is at an known temperature meaning that liquid nitrogen is always existing at the temperature of about minus (−) 195.8°) C (or −320.4° F.) at normal barometric pressure.

According to another exemplary embodiment of the system 101 and method, there is no need to calibrate each RTD 45 after it is manufactured since as each detector 45 comes in contact with liquid nitrogen 67 within a tank 50, it may “detect” liquid nitrogen 67 after the “heating phase” for the second temperature reading described above.

In other words, it is possible that after the level probe is manufactured, each RTD 45 may have a resistivity drift for detecting temperature. But since liquid nitrogen 67 is always a liquid at a known temperature of minus (−) 195.8°) C, then each unique resistivity for each RTD 45 can be calibrated when a particular RTD 45 detects liquid nitrogen after the second temperature reading described above.

For example, suppose a first RTD 45A (see FIG. 6) has a first resistance R1 when it contacts liquid nitrogen and a second RTD 45B has a second resistance R2 when it contacts liquid nitrogen, where R1 and R2 are measured as different values relative to each other for the same liquid nitrogen.

Then the first resistance R1 of the first detector 45A can be equated (set equal to) minus (−) 195.8°) C when it detects liquid nitrogen via the heating cycle discussed above. And similarly, the second resistance R2 of the second detector 45B can be equated (set equal to) minus (−) 195.8°) C when the second RTD 45B detects liquid nitrogen through the RTD heating cycle discussed above.

According to one exemplary embodiment, eight (8) RTDs 45 may be provided along a length of liquid level sensor/column 25. And if liquid nitrogen is provided to fill a dewar 50 completely/entirely (i.e. completely full) so that each detector 45 is positioned within liquid nitrogen, then each detector 45 and its unique resistivity may be calibrated for the temperature of liquid nitrogen (which is minus (−) 195.8°) C as noted above).

While eight RTDs 45 are described above, other numbers of detectors 45 may be employed without departing from the scope of this disclosure. That is, fewer or greater number of detectors 45 may be employed along the column 25 without departing from the scope of this disclosure as understood by one of ordinary skill in the art.

Usually, to identify the present level of the liquid cooling medium 67 in the container 50, it is not necessary to read all RTDs 45. Usually, readings are started at the last known cell in the gas and then readings are taken going down the column 25 one detector 45 to the next detector 45 until liquid 67 is detected. If the container 50 is filled up to its maximum level, the first RTD reading will read the liquid 67 and the reading cycle will restart with the RTD at the top.

Thus, in view of the above, the central controller or MCU 105 may determine the liquid level within the cold storage container 50 by heating the RTDs 45 in a predetermined sequence to detect if a particular RTD 45 is in presence of the liquid form or gaseous form of the cooling medium 67 being measured.

Referring now to FIG. 6, this figure illustrates a side view of a sensor column 25 which contains a plurality of RTDs 45 that are coupled to the modules of FIGS. 2A, 3, and FIG. 5. As explained previously, eight (8) RTDs 45 are located along a length of the sensor column 25. Sensor column 25 may have length of at least about 30 cm according to one exemplary embodiment.

However, the length of the sensor column 25 may be anything (may be shorter or longer). The length of the sensor column 25 depends on the size of the cold storage container 50. The first RTD 45 is generally installed a few centimeters below the maximum liquid level for the cold storage container. The lowest RTD 45 is usually installed at the bottom of the sensor column 25 and the other RTDs 45 are generally, distributed evenly, along the length of the sensor column 25 (in the exemplary embodiment shown in FIG. 6, each RTD 45 is disposed at about every 4.0 cm).

The RTDs 45 are positioned on a rectangular shaped PCB 27b which is enclosed by column 25. The PCB 27b may further comprise rectangular openings/apertures 40. The apertures 40 are present within the PCB 27b in order to reduce the thermal inertia of the sensor column 25.

When the sensor column 25 is removed from the cold storage container 50 for a period of time, it will increase in temperature and when it is inserted, the liquid nitrogen 67 within the container 50 will boil off until the temperature of the sensor column 25 is back to the liquid temperature. So, it is desirable to reduce any evaporation of the liquid nitrogen 67. Each aperture 40 may also reduce the thermal conductivity through the PCB 27b between the warmer top and the colder liquid surface again to reduce liquid nitrogen loss from evaporation due to the temperature differential between the PCB 27b and the cryogenic liquid 67.

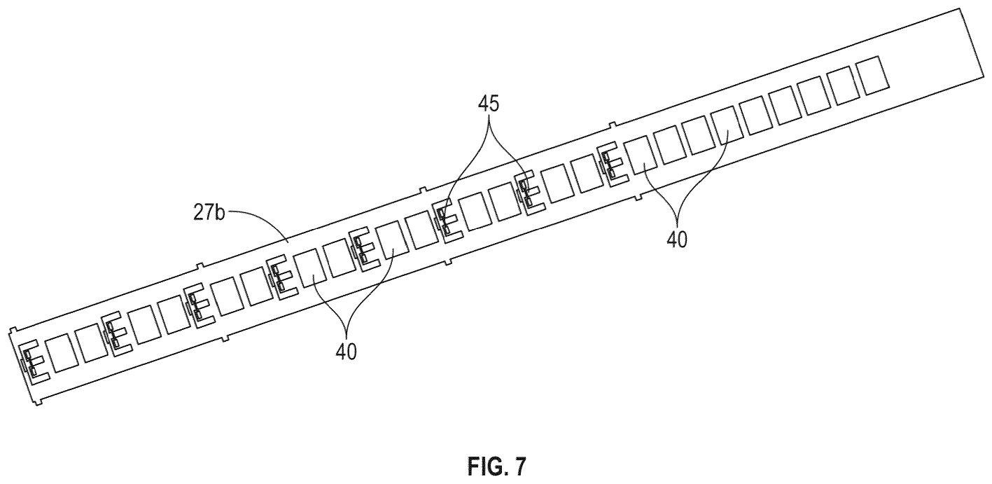

Referring now to FIG. 7, this figure illustrates a side view of the printed circuit board (PCB) 27b that fits within the column 25 of FIG. 6 and which holds the RTDs 45 at predetermined locations along the length of the PCB 27b. As noted previously, the PCB 27b further includes apertures 40 that are positioned between each RTD 45. In this exemplary embodiment of FIG. 7, the apertures 40 appear to have a square shaped geometry instead of a rectangular shaped geometry. Other shapes for apertures 40, besides rectangular and square, are possible and are included within the scope of this disclosure as understood by one of ordinary skill in the art.

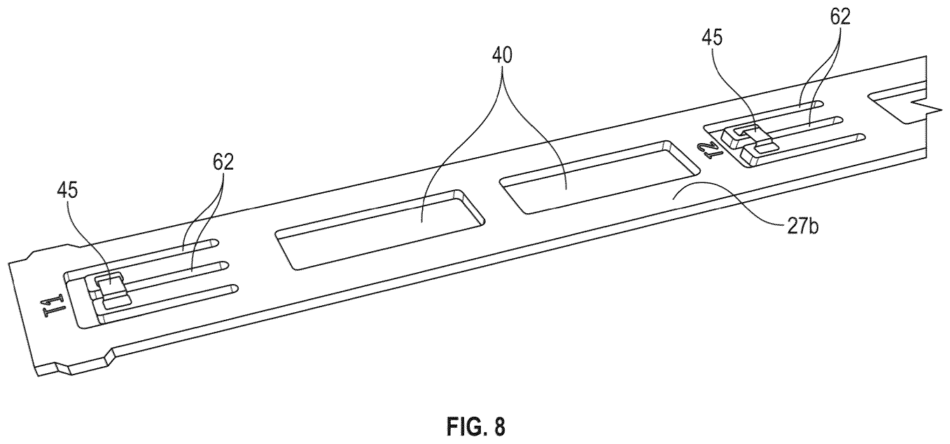

Referring now to FIG. 8, this figure illustrates a magnified view of two RTDs 45 illustrated in FIG. 7. In this figure, legs 62 extend from each RTD 45. The legs 62 are part of the probe column 25 and have copper traces on them to connect to each RTD 45. The legs 62 may reduce the thermal conductivity between the liquid surface and the RTD 45 through the PCB 27b when the RTD 45 is outside the cryogenic liquid 67. With this, even if the RTD 45 is just above the cryogenic liquid 67, there are few centimeters of PCB 27b between the cryogenic liquid 67 (not shown in this figure) and the RTD 45.

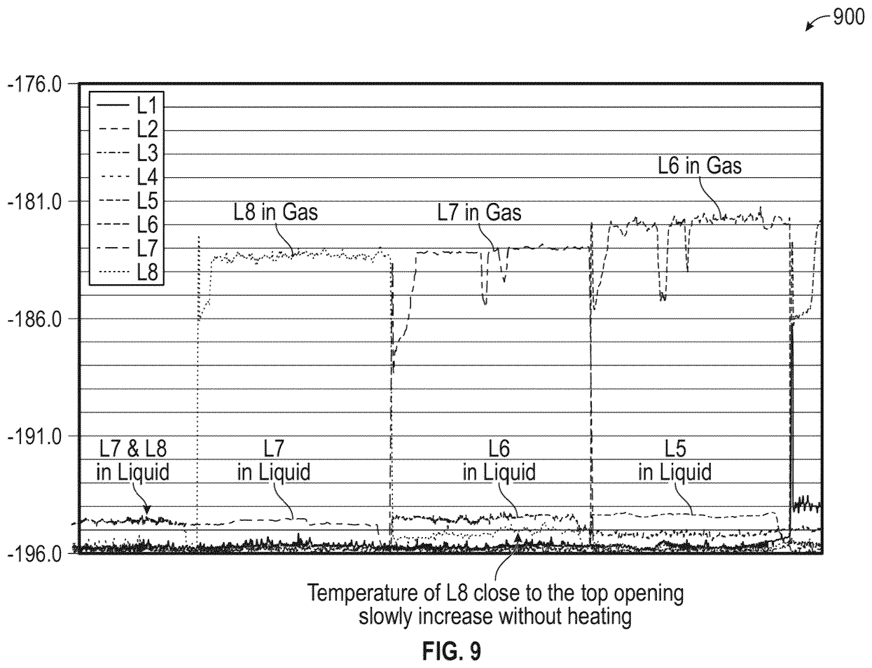

Referring now to FIG. 9, this figure is a graph 900 that has temperature on its Y-axis and time of temperature measurement on the X-axis. This figure represents the reading temperature of heated RTDs 45 over the time.

At the beginning on the left hand side of the graph 900, the dewar is full of liquid, where the liquid may comprise a cryogenic liquid, such as liquid nitrogen (N2) according to one exemplary embodiment The top RTDs L7 and L8 (that is the RTDs 45 positioned closest to the container closure 10 or lid 20) are heated but since they are in the liquid, the temperature rise is at a minimum (i.e. below about 2.0° C. relative to −196.0° C. which is the temperature of liquid N2, the cryogenic liquid for this exemplary embodiment). The RTDs 45 may be numbered L1 through L8, where L8 is closest to the closure 10 or lid 20 and L1 is farthest from the closure 10 or lid 20.

Later, as the cryogenic liquid 67 starts to evaporate over time, and when the liquid surface goes below the RTD L8, the increase in temperature for RTD L8 (after heating) is higher than 5° C. (in this case, almost 13° C. [i.e. measured at −183.0° C. relative to −196.0° C.]). At the same time, RTD L7 is still in the liquid so the temperature rise stays below 2° C.

Later, RTD L7 becomes positioned over the liquid surface as the liquid surface falls due to evaporation. Now, the RTD L6 and L7 are heated and RTD L8 is not heated anymore by the central controller 105. After heating RTDs L6 & L7, the temperature rise of L6 is below about 2.0° C. and the temperature rise of L7 is about over 5.0° C. so liquid level of the cryogenic liquid 67 is known to be between RTD L6 and RTD L7.

This behavior will be repeated with all RTDs 45 down to the last RTD L1 following the movement of the liquid surface for the cryogenic liquid 67 as it evaporates/changes phase over time. When the cryogenic liquid 67 level is below RTD L1 (container almost empty), L1 and L2 will be heated and both will show a temperature rise over about 5.0° C.

After the system 101 via the central controller 105 determines the present level of the cryogenic liquid 67 in the cold storage container 50, the system 101 may then calculate a cooling capacity, usually measured in days, of how long the container 50 will remain at the temperature of minus (−) 195.8° C.) A total duration may be determined (time from full to empty). And using the liquid level percentage, the remaining duration for the cooling capacity is calculated. This duration is usually measured in days, but other time increments are possible. That is, other time increments included, but are not limited to, hours, minutes, seconds, milliseconds, etc.

One challenge of the system 101 is to determine the total duration in which the liquid level percentage will be applied. These calculations are based on and are unique to the size/shape of the cold storage container 50 (i.e. how much cryogenic liquid 67 can the container 50 hold when it has product 60 also contained/stored in the cold storage container 50) and the vacuum insulation, and thermal conduction properties inherent to the container 50 construction.

According to one exemplary embodiment of the system 101, and according to one exemplary size of the cold storage container 50, when there is no product in the cold storage container 50, the cold storage container 50 illustrated in FIG. 4 may have a capacity to hold about 38.0 liters of a cryogenic liquid 67, such as liquid nitrogen. With product(s) 60 inside (i.e. such as, but not limited to, animal vaccines) the cold storage container 50, the quantity of the cryogenic liquid is less so the liquid level of the cryogenic liquid 67 will reduce faster.

As noted previously, other cryogenic liquids 67, beside liquid nitrogen (N2), may be used without departing from the intent and scope of this disclosure. Other cryogenic liquids 67 include, but are not limited to, liquid helium, liquid neon, liquid hydrogen, liquid argon, liquid krypton, liquified methane, liquefied carbon monoxide, and liquefied natural gas. Such other cryogenic liquids 67 will have different boiling/liquid phase temperatures as understood by one of ordinary skill in the art so the RTDs 45 would be calibrated based on these other temperatures.

Also, during usage of the cold storage container 50, some product(s) 60 during transport may be removed resulting in a reduction of the liquid level (i.e. at a first location, some or a portion of the product 60 may be removed from the cold storage container 50 while the product 60 remaining in the cold storage container 50 is moved on to a second location). Normally, a pessimistic (i.e. more conservative) total duration may be established by the system 101 and each time a RTD 45 is reached by the cryogenic liquid level in the container 50, the remaining cooling capacity time for the cold storage container 50 is adjusted.

For example: with eight (8) RTDs 45 disposed along a sensor column 25, the change in cooling capacity for cold storage container 50 is usually about 14.3% when the cryogenic liquid level hits each RTD 45 spaced along the length of the sensor column 25. If the total duration of cold storage for a 38 liter cold storage container 50 is about 63.0 days, each RTD 45 and its corresponding cryogenic liquid level will correspond to a decreased cooling capacity of about 9.0 days. That is, each RTD 45 for a 38 liter cold storage container 50 having a predetermined volume and unique shape will indicate that the cooling capacity for the container has decreased by about 9.0 days as the cryogenic liquid level moves down the sensor column 25 and a corresponding RTD 45 is exposed to gas (no liquid) as the liquid evaporates over time.

According to the exemplary embodiment, where the storage container 50 has a 38 liter capacity for the cryogenic liquid 67 AND also contains product 60, it has been measured that the total cooling capacity of the cold storage container 50 is about 63.0 days. Thus, after about 9.0 days, the remaining days for the cooling capacity is about 54.0 days based on the time elapsed since the full state.

If the next RTD 45 along the sensor column 25 is present within the cryogenic liquid 67 at day 9 (or even at day 10, or day 11, etc.) of the 63.0 total day capacity, then the cooling capacity will be kept at about 54.0 days based on the RTD 45 reading. In other words, the system 101 may track two time tables: (1) time elapsed from a full state of the container and (2) cooling capacity time based on the RTD 45 readings.

Thus, if after about 8.0 days (or even 2.0, 3.0, 4.0 days), and the next RTD 45 is reached by the cryogenic liquid 67, the system will estimate the cooling capacity based on the RTD 45 reading and set the capacity left at 54.0 days, which is one day less than the actual time elapsed (here, at day eight).

Referring now to FIG. 10, this figure illustrates a logic flow chart illustrating exemplary steps of a method 1000 for measuring a liquid level and a cooling capacity of a cold storage container 50. Additional or fewer steps in method 1000 are possible and are included within the scope of this disclosure. The steps may include:

The first step may include step 1005. In step 1005, a sensor column 25 may be formed with a plurality of RTDs 45 spaced along length of the sensor column 25 as illustrated in FIGS. 6-8. As noted previously, the number of RTDs 45 deployed may depend upon the size of the container 50. Therefore, fewer or a greater number of RTDs 45 may be provided than what is illustrated in the Figures.

Next, in step 1010, the sensor column 25, having RTDs 45, may be coupled to a central controller 105 as well as the other modules 115, 120 as illustrated in FIG. 3. As noted previously, as illustrated in FIG. 5, each RTD 45 is coupled to a resistor 506 which is in turn coupled to a heating shift register 502, a reading shift register 504, and analog switch 508. The heating shift register 502, reading shift register 504, and analog switch may be part of and/or may form the acquisition module 115 illustrated in FIG. 3 described above.

Subsequently, in step 1005, the sensor column 25 may be positioned within a cold storage container 50, where the sensor column 25 is part of a container closure 10 which has a lid 20. That is, the container closure 10 which is coupled to the sensor column 25 may be utilized to close/seal the cold storage container 50 as illustrated in FIG. 4 such that the cryogenic liquid/cooling medium 67 does not leak out from the opening at the top of the container 50 while the container 50 is transported from one location to another (i.e. transported by a vehicle, such as, but not limited to, a ground vehicle, an air vehicle like an airplane or drone etc., or by a ship).

Next, in step 1020, the level of the cryogenic liquid 67 within the cold storage container 50 may be measured by the central controller 105 by using the sensor column 25. As noted previously in connection with FIG. 9, the central controller 105 may start measuring the top two RTDs 45 closest to the closure 10 or lid 20 when the container 50 is filled completely with a cryogenic liquid 67 and product 60 (as illustrated in FIG. 4). As the cryogenic liquid 67 starts to evaporate over time, the central controller 105 will activate the next two RTDs 45, moving downward along the sensor column 25 towards the bottom of the container 50, as the liquid level moves downward along the sensor column 25 as it evaporates as understood by one of ordinary skill in the art. The central controller 105 is usually monitoring at least two RTDs 45 that are closest to the liquid level present within the container 50 as explained above in connection with FIG. 9.

Subsequently, in step 1025, the central controller may determine the cooling capacity of the cold storage container 50 based on the liquid level 67 with the central controller 105. As noted previously in connection with FIG. 9, the system 101 with the central controller 105 may calculate a cooling capacity, usually measured in days, of how long the container 50 will remain at the temperature of minus (−) 195.8°) C which is the temperature of liquid nitrogen, the cryogenic liquid 67 according to one exemplary embodiment. As discussed previously, other cryogenic liquids 67 besides liquid nitrogen are possible, and these other cryogenic liquids 67 may have a different temperature for their liquid state compared to liquid nitrogen as understood by one of ordinary skill in the art.

Thus, FIG. 10 shows an exemplary embodiment of a method 1000 for measuring a liquid level 67 within a cold storage container 50 and determining its cooling capacity based on the level of the liquid 67 according to the invention, the method comprising: forming a sensor column 25 by positioning a plurality of resistive temperature detectors (RTDs) 45 along a length dimension of the sensor column 25 (step 1005); coupling the RTDs 45 to a central controller 105 (step 1010); placing the sensor column 25 within a central region of the cold storage container 25 and within a liquid 67 being contained by the cold storage container 50 (step 1015); the central controller 105 measuring the liquid level within the cold storage container 50 using the RTDs 45 (step 1020); and the central controller 105 determining a cooling capacity of the cold storage container 105, the cooling capacity being expressed in units of time (step 1025).

A total duration for the cooling capacity of the cold storage container 50 may be determined by the central controller 105 (time from full to empty). And using the liquid level percentage, the remaining duration for the cooling capacity may be calculated. This duration is usually measured in days, but other time increments are possible. That is, other time increments included, but are not limited to, hours, minutes, seconds, etc.

According to one exemplary embodiment of the system 101, and according to one exemplary size of the cold storage container 50, when there is no product in the cold storage container 50, the cold storage container 50 may have a capacity to hold about 38.0 liters of a cryogenic liquid 67, such as liquid nitrogen. With product(s) 60 inside (i.e. such as, but not limited to, animal vaccines) the cold storage container 50, the quantity of the cryogenic liquid 67 is less so the liquid level of the cryogenic liquid 67 will reduce faster.

Referring back to the method 1000 of FIG. 10, after step 1025, during step 1030 the central controller 105 may determine if the cold storage container 50 is in a tilt position by monitoring the sensor module 110. As noted above, the sensor module 110 represents all sensors located on the system main board 27a. The sensors may include, but are not limited to, board temperature, ambient temperature, barometric pressure, accelerometer and hall effect switches. To detect tilting and movement of the container 50, the central controller 105 may look at data measured by an accelerometer as understood by one of ordinary skill in the art. If the container 50 is in a tilt or non-level position, such a non-level position may cause cryogenic liquid 67 to leak from the container 50, and thus lower the cooling capacity of the container much more quickly than intended/desired.

Next, in step 1035, the central controller 105 may determine if the cold storage container 50 is being transported by an airplane. In this step 1035, the central controller 105 usually processes data received from one or more accelerometers and/or a barometer of the sensor module 110 to determine if motion of the container 50 indicates transportation by an aircraft (i.e. airplane, helicopter, drone, etc.). And specifically, the central controller 105 may also determine from the accelerometers and/or barometer of the sensor module if the aircraft is getting ready and it going through a take-off or landing procedure to gain flight (as is common with jet and propeller airplanes as of this writing).

Subsequently, in step 1040, if it is determined by the central controller 105 in step 1035 that the cold storage container 50 is being transported by an aircraft which is going through a take-off or landing procedure, then the central controller 105 may shut down any wireless modules 125 during the detected take-off or landing procedure as is generally required by most aviation government agencies known as of this writing. After the detection of the take-off or landing procedure, if the central controller 105 determines these aircraft procedures are over, the central controller 105 may re-activate all of the wireless modules 125 responsible for transmitting data to locations remote from the container 50.

Next, in step 1045, the central controller 105 may transmit tilt position data and/or cooling capacity data in a wireless manner over a computer communications network to a remote location. Specifically, with wireless modules 125, the central controller 105 may transmit tilt position data, cooling capacity data, global positioning sensor data, battery power level data, etc. to a remote devices. For example, the central controller 105 may transmit this data over the Internet to one or more remote monitoring devices, which may include, but are not limited to, a server computer, a laptop computer, or a mobile phone and/or any combination thereof.

During step 1045, the central controller 105 may send telemetry data and it may also receive data like setpoints or firmware updates for the system 101. The central controller 105 may also transmit any number of fault/warning conditions it detects to the remote device. Such fault/warnings/conditions may include, but are not limited to, the tilt condition noted above, battery percentage/low power for the power module 120, remaining cooling capacity (usually in days) for the container 50, liquid level for cryogenic liquid 67, high temperature warning (associated with the product), the lid 20/plug 10 being in an open state relative to container 50, etc. etc.

Referring now to FIG. 11A, this figure illustrates an exemplary graphical user interface (GUI) 1100A that can be displayed on the display device 405 illustrated in FIG. 4. The GUI 1100 may comprise a touch-screen where three on-screen buttons 1105A, 1105B, 1105C may be provided for interacting with the GUI 1100 and data presented therein.

Alternatively, the three buttons 1105A, 1105B, 1105C of FIG. 11A may comprise physical buttons or discrete switches positioned adjacent to the GUI 1100 and allow an operator toggle through functions/features/data presented on the GUI 1100. Fewer or additional buttons 1105 may be provided as understood by one of ordinary skill in the art. Also, different interfaces, besides buttons, may be employed without departing from this disclosure such as, but not limited to, a joy-stick, thumb-wheel, track-ball, etc.

Referring back to FIG. 11A, this graphical user interface 1100A may in the first line of data may list the current radio access technology (RAT) for the measuring system 101, which is listed as “LTE” for this exemplary embodiment. LTE is defined as long-term evolution (LTE) and it is a standard for wireless broadband communication for mobile devices and data terminals, and is based on the GSM/EDGE and UMTS/HSPA standards known as of this writing. The measuring system 101 may employ LTE wireless communications, but others known as of this writing are possible and are included within the scope of this disclosure. Other wireless communications include, but are not limited to, Bluetooth, Wi-Fi, GSM, UMTS, and/or or 5G NR. Also, the system 101 may employ other communications besides radio-frequency (RF)-based communications, such as, but not limited to, acoustical communications, optical communications (like infrared), magnetic communications, and the like.

The GUI 1100A may further display the RF signal level which is “P4” in the exemplary embodiment illustrated in FIG. 11A. The RF signal level may have values between 1 and 5 where 5 is the highest RF signal level. The GUI 1100A may also display a reading interval for when the sensor column 25 within the container 50 is read. In the exemplary embodiment of FIG. 11A, the reading interval is “R120” which is a reading interval of about every 120.0 minutes. Other reading intervals shorter or longer are possible and are included within the scope of this disclosure as understood by one of ordinary skill in the art.

The GUI 1100A may further display a transmit interval of when data is transmitted to one or more remote computing devices 420 (see FIG. 4). In the exemplary embodiment illustrated in FIG. 11A, the transmit interval is “T240” which represents a transmit interval of about every 240.0 minutes. Other transmit intervals shorter or longer are possible and are included within the scope of this disclosure as understood by one of ordinary skill in the art.

The GUI 1100A may further display the present level of the cryogenic liquid 67 being detected by the sensor column 25 within the container 50. The present cryogenic liquid level may be conveyed in terms of height of the liquid over the total height of the inner tank of the container 50. In the exemplary embodiment of FIG. 11A, the present cryogenic liquid “Level” is at 79%.

The GUI 1100A may further display the current temperature within the container 50 being detected by the system 101. In the exemplary embodiment of FIG. 11A, the temperature (“Temp”) is currently a value of −190° C.

The GUI 1100A may further display the remaining energy of the power source 130. This present energy level may be expressed in terms of voltage. The voltage of a battery 130 may be converted to the remaining energy in the battery 130 based on a typical voltage curve for a specific chemistry of the battery 130. In the exemplary embodiment illustrated in FIG. 11A, the power source 130 is a battery (“Batt”) and it has a present voltage of about 5.5 volts. However, other units of measure for the remaining energy of the power source 130 are possible, such as in terms of capacity (i.e. mA/hour, etc.).

In the exemplary embodiment illustrated in FIG. 11A, the GUI 1100A may provide access to a menu using the third button 1105C. When the third button 1105 is pressed in FIG. 11A, this causes the system 101 to display the GUI 1100B of FIG. 11B.

Referring now to FIG. 11B, this figure illustrates an exemplary embodiment of a GUI 1100B that is generated in response to a “menu” command being selected in FIG. 11A. The GUI 1100B may display a menu that includes at least three options that may be selected by using the first button 1105A (“toggle down button”) and second button 1105B (“select button”).

The three options illustrated in FIG. 11B include a “Status” option; an “Alarm” option; and a “Communication option.” One of ordinary skill in the art will recognize that the number of options may be fewer or greater than those illustrated. And further, other function/feature options may be presented other than those illustrated in FIG. 11B. That is, the order and/or sequence of the functions/feature options may be varied from those listed in FIGS. 11-12 without departing from the scope of this disclosure.

The GUI 1100 may display an arrow or “greater-than” symbol (“>”) 1110 which indicates that this is the function and/or feature that may be “selected” when the select button 1105B is depressed/selected. So in GUI 1100B, if the select button 1105B is depressed, the “Status” function/feature has been selected since the arrow symbol (“>”) is next to the “Status” menu option. To move the arrow symbol (“>”) downward to select the “Alarm” or “Communication” options, the down button 1105A would need to be pressed as understood by one of ordinary skill in the art.

Referring now to FIG. 11C, this figure illustrates an exemplary GUI 1100C that is generated in response to the “Status” option being selected in the GUI 1100B of FIG. 11B. In the GUI 1100C, there are three options listed under the “STATUS” option which are a “Process” option; a “Device” option; and a “Communication” option. Using the three buttons 1105A (the “down” button), 1105B (the select “sel” button), 1105C (the “back” button), an operator may select any one of these three options with this GUI 1100C.

Referring now to FIG. 11D, this figure illustrates an exemplary GUI 1100D that is generated in response to the “Process” option being selected in the GUI 1100C of FIG. 11C. The GUI 1100D may display some “Process” status information that may include, but is not limited to, the present “Level” of the cryogenic liquid expressed in percentage; the cooling capacity “Remaining” in the container 50 expressed in time units, such as days; and the present measured temperature (“Temp”) within the container 50 expressed in temperature units of Celsius.

In the exemplary embodiment illustrated in FIG. 11D, the first percentage (79%) is the interpolated level (the liquid level between 2 RTDs 45) calculated to estimate the current liquid level of the cryogenic liquid 67. The second percentage (75%) in the parentheses of FIG. 11D is the liquid level based only on one RTD 45. The first percentage (79%) will usually decrease by 1. The second percentage (72%) will usually decrease by step of 14 (for a sensor column having 8 RTDs 45). I For 8 RTDs 45, the second percentage (%) would usually be 100%, 86%, 72%, 58%, 44%, 30%, 16%, 2%, <2%, etc.

The cooling capacity “Remaining” in the container is at about 48.0 days as shown by the second line of the GUI of FIG. 11D (“Remaining: 48 d”). And the present measured temperature (“Temp:”) measured within the container 50 by the system 101 is about minus −190.0° C. Since the GUI 1100D is only a “status” screen, only the back button 1105C can be selected so that the GUI 1100C of FIG. 11C will be displayed.

Referring now to FIG. 11E, this figure illustrates an exemplary GUI 1100E that is generated in response to the “Device” option being selected in the GUI 1100C of FIG. 11C. The GUI 1100E may display/list additional information about the power source 130. In the exemplary embodiment of FIG. 11E, the power source 130 comprises a battery. The GUI 1100E may display a remaining energy of the power source 130 expressed in a percentage; a remaining energy of the power source 130 (i.e. battery) expressed in voltage; and a remaining life of the power source 130 expressed in time units such as in days.

In the exemplary embodiment of FIG. 11E, the remaining energy of the power source 130 (battery “Batt”) in percentage is about 93.0% while voltage of the power source 130 is about 5.5 Volts. And the total “Remaining” energy of the power source 130 expressed in time is about 995.0 days.

Referring now to FIG. 11F, this figure illustrates an exemplary GUI 1100F that is generated in response to the “Next” option being selected in the GUI 1100E of FIG. 11E. The GUI 1100F may display/list additional information about the “Device”/system 101 which may include, but is not limited to, the present ambient barometric pressure outside the container 50 by system 101 (where this pressure is also the same within container 50 since container 50 is not a pressurized tank in this exemplary embodiment); and the exterior or ambient temperature being measured by system 101 outside of the container 50.

In the exemplary embodiment of FIG. 11F, the GUI 1100F is displaying/listing a barometric pressure of about 101.3 kPA ambient pressure being measured by the system 101 and an ambient or outside/external temperature relative to the container 50 of about 24.0° C. being measured by the system 101. According to the GUI 1100F the next button 1105A or the back button 1105C may be selected by the operator.

Referring now to FIG. 11G, this figure illustrates an exemplary GUI 1100G that is generated in response to the “Next” option being selected in the GUI 1100F of FIG. 11F. The GUI 1100F may display/list additional information about the “Device”/system 101 which may include, but is not limited to, a present software (“SW”) version of the system 101; a present hardware (“HW”) version of the system 101; and a serial number (“SN”) assigned to the system 101. In the exemplary embodiment illustrated in FIG. 11G, all three of the numbers listed are “1234567890.” However, the versions and/or serial numbers are not limited to numbers, and may contain letters and/or any combination thereof (i.e. alphanumeric numbers/versions).

Referring now to FIG. 11H, this figure illustrates an exemplary GUI 1100H that is generated in response to the “Communication” option being selected in the GUI 1100C of FIG. 11C. The GUI 1100H may display/list additional information about “Communication” of system 101 which may include, but is not limited to, the radio access technology (“RAT”). In the exemplary embodiment of FIG. 11H, the RAT comprises LTE as described previously in connection with FIG. 11A. As noted previously, other communications besides radio-frequency (RF) communications are possible and include, but are not limited to, acoustical communications, optical communications (like infrared), magnetic communications, and the like.

Referring now to FIG. 11-I, this figure illustrates an exemplary GUI 1100I that is generated in response to the “Alarm” option being selected in the GUI 1100B of FIG. 11B. The GUI 1100H may display/list additional information about “Communication” of system 101 which may include, but is not limited to, the “Current” alarms that are presently active; and a “History” of the past alarms that occurred but may no longer be active. Either the down button 1105A, select button 1105B, or the back button 1105C may be selected with this GUI 1100I.

Referring now to FIG. 11J, this figure illustrates an exemplary GUI 1100J that is generated in response to the “Current” alarm option being selected in the GUI 1100-I of FIG. 11I. The GUI 1100J may display/list additional information about one or more active alarms. In the exemplary embodiment illustrated in FIG. 11J, an “active” alarm of “TILT” is displayed along with date information and time information. For the exemplary “Tilt” alarm of FIG. 11J, a date of Nov. 22, 2023 is displayed along with the time of 15:00 of when the alarm occurred. As noted previously, the measuring system 101 may comprise one or more sensors that include at least accelerometers which may detect unbalanced or tilt conditions of the container 50 when the container 50 is not level relative to the horizon.

In a tilt condition, the container 50 may spill/leak out some of the cryogenic liquid 67 which may reduce the cooling capacity of the container 50 as understood by one of ordinary skill in the art. In addition to displaying this “TILT” alarm on the GUI 1100J of FIG. 11J, the measuring system 101 may also transmit one or more messages containing this tilt alarm to the remote computing device 420 as described above and in connection with FIG. 4. Further, the system 101 may also activate an audible alarm using the speaker 425.

The “ACK” option in FIGS. 11J-11K is an acknowledgment of an alarm. When this option is selected by an operator, the system 101 may silence any audible alarms being transmitted over the speaker 425. Additionally, the system 101 could transmit an “acknowledgment” message to the remote computing device 420 of FIG. 4 to document/store data indicating that the triggered alarm has been acknowledged at the container 50.

Referring now to FIG. 11K, this figure illustrates an exemplary GUI 1100K that is generated in response to the “Current” alarm option being selected in the GUI 1100-I of FIG. 11I and/or in response to the “Next” option being selected in the GUI 1100J in FIG. 11J. The GUI 1100K may display/list additional information about one or more active alarms. In the exemplary embodiment illustrated in FIG. 11K, an “active” alarm of “TEMP HIGH” is displayed. This “TEMP HIGH” alarm may indicate that the temperature inside the container 50 is exceeding the desired/ideal temperature for the product 60.

As noted above, if liquid nitrogen is the cryogenic liquid 67 being used within container 50, then the desired temperature is about minus (−) 195.8° C.) If the temperature within the container goes above this desired temperature, say at minus (−) 188.0 C and above, then this “TEMP HIGH” alarm may be activated by measuring system 101. However, the measuring system 101 may be set/programmed according to the temperature of the cryogenic liquid 67 being used and/or based on a desired temperature for the product 60 being stored in the container 50.

In addition to displaying this “TEMP HIGH” alarm on the GUI 1100K of FIG. 11K, the measuring system 101 may also transmit one or more messages containing this TEMP HIGH alarm to the remote computing device 420 as described above and in connection with FIG. 4. Further, the system 101 may also activate an audible alarm using the speaker 425 of FIG. 4 to indicate this TEMP HIGH alarm.

Referring now to FIG. 11L, this figure illustrates an exemplary GUI 1100L that is generated in response to the “Current” alarm option being selected in the GUI 1100-I of FIG. 11I and/or in response to the “Next” option being selected in the GUI 1100K in FIG. 11K. The GUI 1100L may display/list additional information about one or more active alarms. In the exemplary embodiment illustrated in FIG. 11L, an “active” alarm of “LEVEL LOW” may be displayed. This “LEVEL LOW” alarm may be activated when the cryogenic liquid 67 falls below a predetermined height within the container 50.

While the container 50 may maintain a desired temperature in the container 50, it is possible for the cryogenic liquid 67 to fall below a predetermined/desired height or level within the container 50. This desired height/level of the cryogenic liquid 67 may be set/programmed by the operator of the measuring system 101 so that the container 50 may be re-filled with the cryogenic liquid 67 as needed. In addition to the “LOW LEVEL” text alarm being displayed, the GUI 1100L may also display the date and time this alarm condition was triggered/detected by the measuring system 101.

In addition to displaying this “LOW LEVEL” alarm on the GUI 1100L of FIG. 11L, the measuring system 101 may also transmit one or more messages containing this LOW LEVEL alarm to the remote computing device 420 as described above and in connection with FIG. 4. Further, the system 101 may also activate an audible alarm using the speaker 425 of FIG. 4 to indicate this LOW LEVEL alarm.

Referring now to FIG. 11M, this figure illustrates an exemplary GUI 1100L that is generated in response to the “Current” alarm option being selected in the GUI 1100-I of FIG. 11-I and/or in response to the “Next” option being selected in the GUI 1100L in FIG. 11L. The GUI 1100M may display/list additional information about one or more active alarms. In the exemplary embodiment illustrated in FIG. 11M, an “active” alarm of “STILL OPEN” may be displayed. This “STILL OPEN” alarm may be activated when the lid 20 of the container is not fully closed.

As noted above, the sensor module 110 may be coupled to one or more sensors that may include hall effect sensors, which are generally magnetic switches that may detect a position of the lid 20 relative to the opening of the container 50. If the lid 20 of the container 50 is left open for some period of time, this may cause the cryogenic liquid 67 to evaporate much more quickly since the cryogenic liquid 67 may be exposed to an ambient temperature that is present outside of the insulated container 50. In addition to the “STILL OPEN” text alarm being displayed, the GUI 1100M may also display the date and time this alarm condition was triggered/detected by the measuring system 101.

In addition to displaying this “STILL OPEN” alarm on the GUI 1100L of FIG. 11M, the measuring system 101 may also transmit one or more messages containing this STILL OPEN alarm to the remote computing device 420 as described above and in connection with FIG. 4. Further, the system 101 may also activate an audible alarm using the speaker 425 of FIG. 4 to indicate this STILL OPEN alarm.

Referring now to FIG. 11N, this figure illustrates an exemplary GUI 1100N that is generated in response to the “Alarm History” option being selected in the GUI 1100-I of FIG. 11I. The GUI 1100N may display/list additional information about one or more past and/or active alarms. In the exemplary embodiment illustrated in FIG. 11N, the alarm history includes a listing of the number of alarms that have been triggered/sensed by the measuring system 101 since re-set/the start of the cold storage.

In the exemplary embodiment of FIG. 11N, the GUI 1100N indicates that there was a “TILT” alarm on the 2^{nd} day of the month; a “STILL-OPEN” alarm on the first day of a month; and a “HIGH-TEMP” alarm on the 30^{th} day of a month. Thus, the first column of numbers in the GUI 1100N indicates the numerical day of a month. These three alarms of FIG. 11N were sensed/detected since system 101 re-set or the start of the cold storage for the product 60 within the container 50.

It is noted, that due to the size of the GUI 1100N, the “STILL-OPEN” alarm has been abbreviated as “OPEN” and the “HIGH-TEMP” alarm has been abbreviated as “HIGH.” Other abbreviations are possible and are included within the scope of this disclosure. As noted above, if the display device 405 is larger than what is illustrated in FIGS. 11-12, then abbreviations may not be needed and/or additional text may be displayed on the display device 405. In addition to displaying this “Alarm History” on the GUI 1100N of FIG. 11N, the measuring system 101 may also transmit this alarm history to the remote computing device 420 as described above and in connection with FIG. 4.

Referring now to FIG. 11-O, this figure illustrates an exemplary GUI 1100-O that is generated in response to the “Communication” option being selected in the GUI 1100C of FIG. 11C. The GUI 1100-O may display/list additional information about configuring the communication options available with the measuring system 101. In the exemplary embodiment illustrated in FIG. 11N, the GUI 1100-O may display communication options which may include, but are not limited to, enable, synchronize, mode, and configuring wi-fi communications.

Referring now to FIG. 11P, this figure illustrates an exemplary GUI 1100P that is generated in response to the “Enable” option being selected in the GUI 1100-O of FIG. 11-O. The GUI 1100-O may display/list additional information about configuring the communication options available with the measuring system 101. In the exemplary embodiment illustrated in FIG. 11P, the GUI 1100P may display communication options that include, but are not limited to, Enable, Disable for 1 day, Disable for 2 days, Disable for 5 days, etc.

The “Enable” option of the GUI 1100P of FIG. 11P may allow an operator to select the radio access technology (RAT) described previously. Further details are explained below in connection with FIG. 11Q. The disable options of the GUI 1100P of FIG. 11P allow an operator to shut off communications of the measuring system 101 for predetermined increments of time.

While 1 day, 2 days, and 5 days time increments are illustrated in FIG. 11P, other increments and time units are possible. That is, fewer or a greater number of days may be selected. Further, time units besides days are possible and include, but are not limited to, weeks, months, hours, seconds, etc. Disabling the communications for the measuring system 101 for predetermined periods of time may extend life of the power source 130 (i.e. extend battery life) as RF communications usually consume energy understood by one of ordinary skill in the art.

Referring now to FIG. 11Q, this figure illustrates an exemplary GUI 1100Q that is generated in response to the “Mode” option being selected in the GUI 1100-O of FIG. 11-O. The GUI 1100Q may display/list additional information about configuring the communication options available with the measuring system 101. In the exemplary embodiment illustrated in FIG. 11Q, the GUI 1100Q may display communication options that include, but are not limited to, enabling Wifi & Cellular communications (i.e. “Wifi, Cell) such that the system 101 may transmit and/or receive using either Wifi or Cellular communications; enabling Wifi only; and enabling Cellular communications only (i.e. “Cell only). As noted previously, other forms of communication besides RF are possible and are included within the scope of this disclosure. Other communications/communication links include, but are not limited to, wired and wireless, including acoustical, optical, magnetic, and the like.

Referring now to FIG. 11R, this figure illustrates an exemplary GUI 1100R that is generated in response to the “Config wifi” option being selected in the GUI 1100-O of FIG. 11-O. The GUI 1100R may display/list additional information about configuring the Wifi communication options available with the measuring system 101.

The GUI 1100-O of FIG. 11R allows an operator to configure the Service Set Identifier (SSID) for the WiFi network. The GUI 1100-O may display the current SSID, which in the exemplary embodiment illustrated in FIG. 11R is “ABC123DEF456GH1789.” It is noted this information conveyed in GUI 1100-O, or any of the GUIs illustrated in FIGS. 11-12, may be transmitted to the remote computing device 420.

Referring now to FIG. 11S, this figure illustrates an exemplary GUI 1100S that is generated to activate Bluetooth™ wireless communications (i.e. “Activate BLE”). Since the wireless module 125 running Bluetooth™ wireless communications is not always activated (it may drain the battery 130), this GUI 1100S may be used to activate it. When done, an external remote computing device 420 (i.e. phone, tablet, or computer) having Bluetooth™ wireless capabilities may connect to the system 101 to wirelessly perform operations, and in this case, manage inventory of the container 50.

Referring now to FIG. 11T, this figure illustrates an exemplary GUI 1100T that is generated to calibrate various sensors, such as, but not limited to, the RTDs 45, temperature sensors, and accelerometers. The “Calib RTD” function will calculate the offset required for each RTD to get to the temperature of −195.8° C. (for liquid nitrogen as the exemplary cryogenic liquid 67). The container 50 will usually need to be full of the cryogenic liquid 67 for this RTD calibration. The “Calib Out Temp” function calibrates the temperature sensor that is part of the sensor module 110. The “Calib accel” function/option will calibrate the accelerometer(s) that are coupled to the sensor module 110. The container will usually need to be placed in a horizontal position to perform this calibration function of the accelerometers(s).

Referring now to FIG. 11U, this figure illustrates an exemplary GUI 1100U that is generated in response to the “Calibrate RTD” option being selected in the GUI 1100T of FIG. 11T. The GUI 1100U may display/list options for starting the RTD calibrating process. The GUI 1100U may display a date the RTDs 45 of the measuring system 101 were calibrated.

In the exemplary embodiment of FIG. 11U, this date is listed as Nov. 22, 2023. If the yes button 1105A is selected, then the calibration process for the RTDs 45 will begin. The information presented in FIG. 11U may be transmitted by the measuring system 101 to the remote computing device 420 as illustrated in FIG. 4. Further, the remote computing device 420 may also initiate/start the calibration process of the RTDs 45 by transmitting one or more commands in response to the info presented from GUI 1100U.

Referring now to FIG. 11V, this figure illustrates an exemplary GUI 1100V that is generated in response to the “Calibrate Out Temp” option being selected in the GUI 1100T of FIG. 11T. The GUI 1100T may display/list options for starting the outside temperature sensors calibrating process. The GUI 1100U may display a date the outside temperature sensors which are coupled to the sensor module 110 of the measuring system 101 were calibrated.

The GUI 1100V may display a date the outside temperature sensors of the measuring system 101 were calibrated. In the exemplary embodiment of FIG. 11V, this date is listed as Nov. 22, 2023. If the yes button 1105A is selected, then the calibration process for the outside temperature sensors will begin. The information presented in FIG. 11V may be transmitted by the measuring system 101 to the remote computing device 420 as illustrated in FIG. 4. Further, the remote computing device 420 may also initiate/start the calibration process of the outside temperature sensors by transmitting one or more commands in response to the information presented from GUI 1100U.

Referring now to FIG. 11W, this figure illustrates an exemplary GUI 1100W that is generated in response to the “Calibrate ACCEL” option being selected in the GUI 1100T of FIG. 11T. The GUI 1100W may display/list options for starting the accelerometers/sensors calibrating process. The accelerometers may be part of and/or coupled to the sensor module 110, as described above, and may be responsible for detecting the “TILT” condition/alarm described above.

The GUI 1100W of FIG. 11W may display a date the accelerometers of the measuring system 101 were last calibrated. In the exemplary embodiment of FIG. 11W, this date is listed as Nov. 22, 2023. The GUI 1100W may also provide instructions, such as, but not limited to, instructing the operator to confirm the container 50 is in a horizontal position relative to the ground/earth before starting the calibration process by hitting the yes button 1105A.

Referring now to FIG. 11X, this figure illustrates an exemplary GUI 1100X that is generated to adjust the reading intervals of the sensor column 25 and the transmit interval/timing for the measuring system 101 to communicate with the remote computing device 420 of FIG. 4. The GUI 1100X may display/list a first option to select the reading interval (“Reading Intr”) and a second option to select the transmitting interval (“Transmit Intr”).

Referring now to FIG. 11Y, this figure illustrates an exemplary GUI 1100Y that is generated in response to the “Reading Interval” option being selected in the GUI 1100X of FIG. 11X. The GUI 1100Y may display/list options for increasing or decreasing the reading interval. According to the exemplary embodiment illustrated in FIG. 11Y, the “new” reading interval is shown as about 120.0 minutes; and the previous “prev” reading interval is shown as about 120.0 minutes.

Using the increase button 1105A and/or decrease button 1105B, an operator may increase and/or decrease the reading interval. While the time increments of minutes are illustrated in GUI 1100X, other time increments may be used and may include, but are not limited to, seconds, milliseconds, hours, days, weeks, months, etc. As noted previously, the GUI 1100X may be transmitted to the remote computing device 420 and the remote computing device 420 may be used by an operator to select the desired reading interval for the RTDs 45 of the sensor column 25.

Referring now to FIG. 11Z, this figure illustrates an exemplary GUI 1100X that is generated in response to the “Transmit Interval” option being selected in the GUI 1100X of FIG. 11X. The GUI 1100Z may display/list options for increasing or decreasing the transmit interval where the measuring system 101 usually transmits over radio-frequency (RF) waves to the remote computing device 420 using the communications/wireless module 125 of FIG. 3. According to the exemplary embodiment illustrated in FIG. 11Z, the “new” transmitting interval is shown as about 240.0 minutes; and the previous “prev” transmitting interval is shown as about 240.0 minutes.

Using the increase button 1105A and/or decrease button 1105B, an operator may increase and/or decrease the transmitting interval. While the time increments of minutes are illustrated in GUI 1100Z, other time increments may be used and may include, but are not limited to, seconds, milliseconds, hours, days, weeks, months, etc. As noted previously, the GUI 1100Z may be transmitted to the remote computing device 420 and the remote computing device 420 may be used by an operator to select the desired transmitting interval for the communications/wireless module 125.

Referring now to FIG. 12A, this figure illustrates an exemplary GUI 1200A that is generated to allow for a selection of a development mode (“Dev mode” for the measuring system 101 of the container 50. When the “DEV mode” is enabled, debug data may be transmitted on a programming port (not illustrated, but located on the PCB 27a of FIG. 2A) for debugging/programming purposes. The development mode is not usually used for normal/routine operations of the measuring system 101.

Referring now to FIG. 12B, this figure illustrates an exemplary GUI 1200B that is generated to allow an operator to shut down or turn off the measuring system 101 of the container 50. The GUI 1200B may display a “new” mode that is desired and a current “Cur” mode of the system 101. If the ok button 1105A is selected in the GUI 1200B, then this will select the “new” mode of SHUTDOWN which shuts off the measuring system 101. As described previously, this GUI 1200B, as well as others, may be transmitted to the remote computing device 420 and the remote computing device 420 may be used to the select the different modes/options presented by the GUI 1200B.

Referring now to FIG. 12C, this figure illustrates an exemplary GUI 1200C that is generated to allow an operator to select the type of power source 130 (i.e. battery type) for the measuring system 101. According to the exemplary embodiment of FIG. 12C, the GUI 1200C may display a “Li/Fe” option for Lithium-Iron batteries and an “Alkaline” option if alkaline batteries are being used as the power source 130.

Other batteries besides these two types of GUI 1200C are possible and are included within the scope of this disclosure. As described previously, this GUI 1200C may be transmitted to the remote computing device 420 and the remote computing device 420 may be used to the select the different modes/options presented by the GUI 1200C, that includes battery types in GUI 1200C.

Referring now to FIG. 12D, this figure illustrates an exemplary GUI 1200D that is generated to allow an operator to select and view a data history for certain data parameters/variables tracked by the measuring system 101. According to the exemplary GUI 1200D of FIG. 12D, a least three histories are available for voltage levels (i.e. “voltage”); a level history (i.e. “level”); and an internal temperature of the container 50 (i.e. “temp in”). Other histories for other variables may include, but are not limited to, outside temperatures, number of container openings, barometric pressure, and alarms, as described previously. These may be listed on the GUI 1200D and accessed by scrolling down the menu presented in GUI 1200D of FIG. 12D.

Any of the three options (or others accessed by scrolling and) listed in FIG. 12D may be selected using the down button 1105A and/or select button 1105B. As described previously, this GUI 1200D may be transmitted to the remote computing device 420 and the remote computing device 420 may be used to the select the histories presented by the GUI 1200D.

Referring now to FIG. 12E, this figure illustrates an exemplary GUI 1200E that is generated in response to the “Voltage” history option being selected in the GUI 1200D of FIG. 12D. The GUI 1200E may display/list the voltage history for the power source 130 of the system 101.

The GUI 1200E may also provide an option to generate a graph of the voltage history over time with a graph button 1105B. As described previously, this GUI 1200E may be transmitted to the remote computing device 420 and the remote computing device 420 may be used to the view or select the histories presented by the GUI 1200D.

Referring now to FIG. 12F, this figure illustrates an exemplary GUI 1200F that is generated in response to the “Voltage” graph option being selected in the GUI 1200E of FIG. 12E. The GUI 1200F may display/list the voltage history in the format of graph of time vs. voltage for the power source 130 of the system 101. As described previously, this GUI 1200F may be transmitted to the remote computing device 420 and the remote computing device 420 may be used to the view or select the histories presented by the GUI 1200F.

Referring now to FIG. 12G, this figure illustrates an exemplary GUI 1200G that is generated to allow an operator to couple a remote computing device 420 to the measuring system 101 by producing a machine-readable code, such as, but not limited to, a two-dimensional bar-code on the display device 405. The two-dimensional bar-code may be scanned with a remote computing device 420, such as a camera of a mobile telephone. The two-dimensional bar-code may open a web browser of the remote computing device 420 and take the operator to a web page associated with the serial number of the measuring system 101. Other machine-readable codes may be used without departing from this disclosure (i.e. such as, but not limited to, one-dimensional, three-dimensional, Aztec codes, QR codes, etc., etc.).

Certain steps in the exemplary method 1000 of FIG. 10 described herein naturally precede others for the invention to function as described. However, the invention is not limited to the order of the steps described if such order or sequence does not alter the functionality of the system and method of the present disclosure.

That is, it is recognized that some steps may performed before, after, or parallel (substantially simultaneously with) other steps without departing from the scope and intent of this disclosure. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the technical diagrams and/or flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another.

A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

In exemplary embodiments, the present invention relates to the following aspects, which may be realized independently but also in any combination with the aforementioned aspects, features and characteristics:

1. A system 101 for determining a cooling capacity of a cold storage container 50, the system 101 comprising: a sensor device 25 having a plurality of detectors 45; a controller 105 coupled to the sensor device 25, in particular the detectors 45; and a cold storage container 50 receiving or comprising the sensor device 25, wherein the controller 105 and/or sensor device 25 is/are configured to measure a liquid level within the cold storage container 50, and wherein the controller 105 is configured to determine a cooling capacity of the cold storage container 50 based on the measured liquid level.

2. The system of aspect 1, wherein the controller 105 is configured to determine if the cold storage container 50 is in a tilt position, in particular based on a signal from a tilt sensor and/or accelerometer coupled to the controller 105.

3. The system of aspect 1 or 2, wherein the controller 105 is configured to determine if a container closure 10 has been opened or removed from the cold storage container 50, in particular based on a signal from a hall effect sensor coupled to the controller 105.

4. The system of one of the preceding aspects, wherein the controller 105 is configured to determine if the cold storage container 50 is being transported by an aircraft, in particular based on a signal from an accelerometer and/or a barometer coupled to the controller 105.

5. The system of aspect 4, wherein the controller 105 is configured to determine if the aircraft is in a take-off or landing procedure, preferably wherein the controller 105 is configured to temporarily disable wireless transmissions if it has been determined that the aircraft is in a take-off or landing procedure.

6. The system of one of the preceding aspects, wherein the controller 105 is configured to wirelessly transmit data, in particular the measured liquid level and/or the determined cooling capacity, over a computer communications network to a remote device.

7. The system of one of the preceding aspects, wherein the controller 105 is configured to determine the liquid level within the cold storage container 50 by heating the detectors 45, and in particular based on temperatures measured with the detectors 45 before and after heating, preferably wherein the controller is configured for performing the heating in a predetermined sequence.

8. The system of aspect 7, wherein the heating of the detectors 45, in particular the heating in the predetermined sequence, allows the controller 105 to detect if the detectors 45, are in presence of a liquid or a gas.

9. The system of one the preceding aspects, wherein the detectors 45 are temperature detectors, in particular resistive temperature detectors (RTDs).

10. The system of one of the preceding aspects, wherein the detectors 45 are positioned along a length of the sensor device 25 and/or along a straight line, in particular in equal distances, and/or the sensor device 25 is configured as a sensor column.

11. The system of one the preceding aspects, wherein a liquid that provides the liquid level being measured within the cold storage container 50 is or comprises a cryogenic liquid 67.

12. The system of aspect 11, wherein the cryogenic liquid 67 is or comprises at least one of liquid nitrogen, liquid helium, liquid neon, liquid hydrogen, liquid argon, liquid krypton, liquefied methane, liquefied carbon monoxide, and liquefied natural gas.

13. The system of one the preceding aspects, wherein the cooling capacity is expressed in units of time.

14. The system of aspect 13, wherein the units of time comprises at least one of days, hours, minutes, seconds, and milliseconds.

15. A method for determining a cooling capacity of a cold storage container 50, the method comprising: providing a sensor device 25 having a plurality of detectors 45 for detecting a liquid level within the cold storage container 50 and a controller 105 coupled to the sensor device 25, in particular the detectors 45, placing the sensor device 25 in contact with a liquid being contained by the cold storage container 50; measuring the liquid level within the cold storage container 50 with the sensor device 25 and/or the controller 105; and determining with the controller 105 a cooling capacity of the cold storage container 50 based on the measured liquid level.

16. The method of aspect 15, wherein the liquid is or comprises a cryogenic liquid 67.

17. The method of aspect 16, wherein the cryogenic liquid 67 is or comprises at least one of liquid nitrogen, liquid helium, liquid neon, liquid hydrogen, liquid argon, liquid krypton, liquefied methane, liquefied carbon monoxide, and liquefied natural gas.

18. The method of one of aspects 15 to 17, wherein the controller 105 determines if the cold storage container 50 is in a tilt position, in particular based on a signal from a tilt sensor and/or accelerometer coupled to the controller 105.

19. The method of one of aspects 15 to 18, wherein the controller 105 determines if a container closure 10 has been opened or removed from the cold storage container 50, in particular based on a signal from a hall effect sensor coupled to the controller 105.

20. The method of one of aspects 15 to 19, wherein the controller 105 determines if the cold storage container 50 is being transported by an aircraft, in particular based on a signal from an accelerometer and/or a barometer coupled to the controller 105.

21. The system of aspect 20, wherein the controller 105 determines if the aircraft is in a take-off or landing procedure, preferably wherein the controller 105 temporarily disables wireless transmissions if it has been determined that the aircraft is in a take-off or landing procedure.

22. The method of one of aspects 15 to 21, wherein the controller 105 wirelessly transmits data, in particular the measured liquid level and/or the determined cooling capacity, over a computer communications network to a remote device.

23. The method of one of aspects 15 to 22, wherein the controller 105 and/or sensor device 25 measures the liquid level within the cold storage container 50 by heating the detectors 45 and in particular based on temperatures measured with the detectors 45 before and after heating, preferably wherein the heating is performed in a predetermined sequence.

24. The method of aspect 23, wherein the heating of the detectors 45 by the controller 105, in particular the heating in the predetermined sequence, allows the controller 105 to detect if the detectors 45 are in presence of a liquid or a gas.

25. The method of one of aspects 15 to 24, wherein the detectors 45 are temperature detectors, in particular resistive temperature detectors (RTDs).

26. The method of one of aspects 15 to 25, wherein the detectors 45 are positioned along a length of the sensor device 25 and/or along a straight line, in particular in equal distances, and/or the sensor device is configured as a sensor column.

27. The method of one of aspects 15 to 26, wherein the cooling capacity is expressed in units of time.

28. The method of aspect 27, wherein the units of time comprises at least one of days, hours, minutes, seconds, and milliseconds.

29. The method of one of aspects 15 to 27, wherein the method is performed with a system according to one of aspects 1 to 14.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

It is noted that several of the figures provide exhaustive detail which would allow one of ordinary skill in the art to make, build, and use the inventive system as intended. Thus, the several figures of this disclosure are enabling to one of ordinary skill in the art. Further, text explanations may not be necessary for several of the figures since the old axiom holds true for the attached figures: a picture is worth a thousand words, as understood by one of ordinary skill in the art.

Alternative embodiments for the system and method of the present disclosure will become apparent to one of ordinary skill in the art to which the invention pertains without departing from the intent and/or scope of this written disclosure. Therefore, although selected aspects have been illustrated and described in detail above, it will be understood that various substitutions and alterations may be made therein without departing from scope of this written disclosure, as defined by the following claims.

LIST OF REFERENCE SIGNS

| | |
|---|---|
| 10 | Container closure/plug/cork |
| 20 | Cover/lid |
| 23 | Grooves |
| 25 | Sensor device/column |
| 27a | Printed circuit board |
| 27b | Printed circuit board |
| 29 | Holes |
| 30 | Grooves |
| 31 | Posts |
| 35 | Communication line |
| 37 | Enclosure |
| 40 | Aperture |
| 45 | Detector/RTD |
| 45A | First detector/RTD |
| 45B | Second detector/RTD |
| 50 | Cold storage container |
| 60 | Product |
| 62 | Legs |
| 67 | Cryogenic liquid/cooling medium |
| 101 | System |
| 105 | (Central) controller |
| 110 | Sensor module |
| 115 | Acquisition module |
| 120 | Power module |
| 125 | Wireless module |
| 130 | Power source |
| 405 | Display device |
| 415 | Communication link |
| 420 | Remote/Portable computing device |
| 425 | Speaker |
| 502 | Heating shift register |
| 504 | Shift register |
| 506 | Resistor |
| 508 | Analog switch |
| 1000 | Method |
| 1005 | Step |
| 1010 | Step |
| 1015 | Step |
| 1020 | Step |
| 1025 | Step |
| 1030 | Step |
| 1035 | Step |
| 1040 | Step |
| 1045 | Step |
| 1100A-Z | GUI |
| 1105A-C | Buttons |
| 1200A-G | GUI |

What is claimed is:

1. A system for measuring a liquid level within a cold storage container and determining its cooling capacity based on the liquid level, the system comprising:
a sensor column having a length dimension and a plurality of resistive temperature detectors (RTDs) positioned along the length dimension, the sensor column being placed within a central region of the cold storage container;
a central controller coupled to the plurality of RTDs; and
the cold storage container receiving the sensor column, wherein the central controller may determine a liquid level within the cold storage container, and based on the liquid level, the central controller determines a cooling capacity of the cold storage container.

2. The system of claim 1, wherein the central controller determines if the cold storage container is in a tilt position.

3. The system of claim 1, wherein the central controller determines if a container closure has been opened or removed from the storage container.

4. The system of claim 1, wherein the central controller determines if the cold storage container is being transported by an aircraft.

5. The system of claim 4, wherein the central controller determines if the aircraft is in a take-off or landing procedure, and if the aircraft is in the take-off or landing procedure, the central controller temporarily disables wireless transmissions.

6. The system of claim 1, wherein the central controller wirelessly transmits data over a computer communications network to a remote device.

7. The system of claim 1, wherein the central controller determines the liquid level within the cold storage container by heating the RTDs in a predetermined sequence.

8. The system of claim 7, wherein the heating of the RTDs in the predetermined sequence allows the central controller to detect if the RTD is in presence of a liquid form or a gas.

9. The system of claim 1, wherein a liquid that provides the liquid level being measured within the container comprises a cryogenic liquid.

10. The system of claim 9, wherein the cryogenic liquid comprises at least one of liquid nitrogen, liquid helium, liquid neon, liquid hydrogen, liquid argon, liquid krypton, liquified methane, liquefied carbon monoxide, and liquefied natural gas.

11. A method for measuring a liquid level within a cold storage container and determining its cooling capacity based on the liquid level, the method comprising:
forming a sensor column by positioning a plurality of resistive temperature detectors (RTDs) along a length dimension of the sensor column;
coupling the RTDs to a central controller;
placing the sensor column within a central region of the cold storage container and within a liquid being contained by the cold storage container;
the central controller measuring the liquid level within the cold storage container using the RTDs; and
the central controller determining a cooling capacity of the cold storage container, the cooling capacity being expressed in units of time.

12. The method of claim 11, wherein the liquid comprises a cryogenic liquid.

13. The method of claim 12, wherein the cryogenic liquid comprises at least one of liquid nitrogen, liquid helium, liquid neon, liquid hydrogen, liquid argon, liquid krypton, liquified methane, liquefied carbon monoxide, and liquefied natural gas.

14. The method of claim 11, wherein the central controller determines if the cold storage container is in a tilt position.

15. The method of claim 11, wherein the central controller determines if a container closure has been opened or removed from the storage container.

16. The method of claim 11, wherein the central controller determines if the cold storage container is being transported by an aircraft.

17. The method of claim 11, wherein the central controller wirelessly transmits data over a computer communications network to a remote device.

18. The method of claim 11, wherein the central controller measures the liquid level within the cold storage container by heating the RTDs in a predetermined sequence.

19. The method of claim 18, wherein the heating of the RTDs by the central controller in the predetermined sequence allows the central controller to detect if the RTD is in presence of a liquid or a gas.

20. The method of claim 11, wherein the units of time comprises at least one of days, hours, minutes, seconds, and milliseconds.
